(19) United States
(12) Patent Application Publication
(10) Pub. No.: US 2024/0098619 A1
(43) Pub. Date: Mar. 21, 2024

(54) SIDELINK UNLICENSED CHANNEL RELAY SELECTION

(71) Applicant: QUALCOMM Incorporated, San Diego, CA (US)

(72) Inventors: Sherif Elazzouni, San Diego, CA (US); Ozcan Ozturk, San Diego, CA (US); Xiaoxia Zhang, San Diego, CA (US); Qing Li, PRINCETON JUNCTION, NJ (US); Jing Sun, San Diego, CA (US); Junyi Li, Fairless Hills, PA (US); Piyush Gupta, Bridgewater, NJ (US)

(21) Appl. No.: 17/949,056

(22) Filed: Sep. 20, 2022

(51) Int. Cl. H04W 40/22; H04W 24/08; H04W 76/30

(52) U.S. Cl. CPC H04W 40/22; H04W 24/08; H04W 76/30

(57) ABSTRACT

Methods, systems, and devices for wireless communication are described. A first user equipment (UE) may determine to perform a relay selection procedure and receive respective messages from one or more second UEs including one or more parameters for selecting a second UE to relay communications between the first UE and a network entity. The first UE may determine that respective parameters satisfy a threshold and select the second UE associated with the respective parameters. In some cases, the first UE may receive a control message prior to performing the relay selection procedure. The control message may include a configuration for modifying the communication path that includes an indication of one or more candidate UEs for relaying communications between the first UE and the network entity.

### FIELD OF TECHNOLOGY

The following relates to wireless communication, including sidelink unlicensed channel relay selection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support sidelink unlicensed channel relay selection. For example, the described techniques provide for updated relay selection procedures associated with the unlicensed channel, which may result in more efficient utilization of resources and increased data rate. For example, a first user equipment (UE) (e.g., a remote UE) may determine to perform a relay selection procedure and receive respective messages (e.g., relay discovery messages) from one or more second UEs (e.g., relay UEs) including one or more parameters (e.g., parameters associated with the unlicensed channel) for selecting a second UE to relay communications between the first UE and a network entity. The first UE may determine that respective parameters satisfy a threshold (e.g., a performance threshold) and select the second UE associated with the respective parameters. In some cases, the first UE may receive a control message prior to performing the relay selection procedure. The control message may include a configuration for modifying the communication path that includes an indication of one or more candidate UEs for relaying communications between the first UE and the network entity. In some examples, the configuration may indicate a condition associated with a link between a relay UE and the network entity or a condition associated with a link between the UE and the network entity (e.g., without a relay UE). The first UE may detect the condition (e.g., a measurement associated with channel access satisfying a threshold) and modify the communication path based on detecting the condition.

A method for wireless communication at a first UE is described. The method may include receiving, from one or more other UEs based on determining that a sidelink measurement associated with the one or more other UEs satisfies a first threshold, a message including one or more parameters associated with channel access by the one or more other UEs, where the one or more other UEs are candidate UEs for relaying communications between the first UE and a network entity, selecting a second UE of the one or more other UEs for relaying communications between the first UE and the network entity based on the one or more parameters satisfying a second threshold, and communicating with the network entity via the second UE based on selecting the second UE for relaying the communications.

An apparatus for wireless communication at a first UE is described. The apparatus may include a processor, memory coupled with the processor, and instructions stored in the memory. The instructions may be executable by the processor to cause the apparatus to receive, from one or more other UEs based on determining that a sidelink measurement associated with the one or more other UEs satisfies a first threshold, a message including one or more parameters associated with channel access by the one or more other UEs, where the one or more other UEs are candidate UEs for relaying communications between the first UE and a network entity, select a second UE of the one or more other UEs for relaying communications between the first UE and the network entity based on the one or more parameters satisfying a second threshold, and communicate with the network entity via the second UE based on selecting the second UE for relaying the communications.

Another apparatus for wireless communication at a first UE is described. The apparatus may include means for receiving, from one or more other UEs based on determining that a sidelink measurement associated with the one or more other UEs satisfies a first threshold, a message including one or more parameters associated with channel access by the one or more other UEs, where the one or more other UEs are candidate UEs for relaying communications between the first UE and a network entity, means for selecting a second UE of the one or more other UEs for relaying communications between the first UE and the network entity based on the one or more parameters satisfying a second threshold, and means for communicating with the network entity via the second UE based on selecting the second UE for relaying the communications.

A non-transitory computer-readable medium storing code for wireless communication at a first UE is described. The code may include instructions executable by a processor to receive, from one or more other UEs based on determining that a sidelink measurement associated with the one or more other UEs satisfies a first threshold, a message including one or more parameters associated with channel access by the one or more other UEs, where the one or more other UEs are candidate UEs for relaying communications between the first UE and a network entity, select a second UE of the one or more other UEs for relaying communications between the first UE and the network entity based on the one or more parameters satisfying a second threshold, and communicate with the network entity via the second UE based on selecting the second UE for relaying the communications.

Some examples of the method, apparatuses, and non-transitory computer-readable medium described herein may further include operations, features, means, or instructions for determining a quantity of failures associated with a link between the first UE and a third UE within a time duration and determining that the quantity of failures satisfies a third threshold, where selecting the second UE for relaying communications may be further based on the quantity of failures satisfying the third threshold.

Some examples of the method, apparatuses, and non-transitory computer-readable medium described herein may further include operations, features, means, or instructions for storing an indication of the link between the first UE and the third UE based on determining that the quantity of failures satisfies the third threshold, where selecting the second UE rather than the third UE for relaying communications between the first UE and the network entity may be based on storing the indication of the link between the first UE and the third UE.

Some examples of the method, apparatuses, and non-transitory computer-readable medium described herein may further include operations, features, means, or instructions for receiving, from a third UE configured to relay communications between the first UE and the network entity, a second message indicating one or more failures associated with a first link between the third UE and the network entity within a time duration and determining whether to release a second link between the first UE and the third UE based on the one or more failures.

Some examples of the method, apparatuses, and non-transitory computer-readable medium described herein may further include operations, features, means, or instructions for transmitting, to a third UE configured for relaying communications between the first UE and the network entity, a control message including the one or more parameters and receiving an indication to perform a communication path modification based on transmitting the control message, where selecting the second UE may be further based on the indication.

Some examples of the method, apparatuses, and non-transitory computer-readable medium described herein may further include operations, features, means, or instructions for receiving a second message including a second indication to transmit the control message, where transmitting the control message may be based on receiving the second message.

In some examples of the method, apparatuses, and non-transitory computer-readable medium described herein, the one or more parameters include a combination of a likelihood of failure associated with a first link between the first UE and the one or more other UEs and a likelihood of failure associated with a second link between the one or more other UEs and the network entity.

In some examples of the method, apparatuses, and non-transitory computer-readable medium described herein, the message may be a discovery message associated with a relay selection procedure.

In some examples of the method, apparatuses, and non-transitory computer-readable medium described herein, the one or more parameters for reselection includes a listen-before-talk (LBT) counter, a channel busy ratio (CBR) value, a likelihood of failure of a LBT procedure associated with a link between the first UE and the second UE, or any combination thereof.

In some examples of the method, apparatuses, and non-transitory computer-readable medium described herein, the LBT counter includes an average of LBT failures associated with one or more links between a respective UE of the one or more other UEs and a respective third UE.

Some examples of the method, apparatuses, and non-transitory computer-readable medium described herein may further include operations, features, means, or instructions for measuring interference at the first UE, where the CBR value may be associated with the interference.

A method for wireless communication at a first UE is described. The method may include communicating with a network entity over a communication path including a first link between the first UE and a second UE, the second UE configured to relay communications between the first UE and the network entity, receiving a control message including a configuration for modifying the communication path based on a condition associated with channel access, where the configuration indicates one or more candidate UEs for relaying the communications between the first UE and the network entity upon satisfaction of the condition, and selecting a candidate UE of the one or more candidate UEs to establish a second link between the first UE and the candidate UE based on the configuration and determining that the condition associated with channel access is satisfied.

An apparatus for wireless communication at a first UE is described. The apparatus may include a processor, memory coupled with the processor, and instructions stored in the memory. The instructions may be executable by the processor to cause the apparatus to communicate with a network entity over a communication path including a first link between the first UE and a second UE, the second UE configured to relay communications between the first UE and the network entity, receive a control message including a configuration for modifying the communication path based on a condition associated with channel access, where the configuration indicates one or more candidate UEs for relaying the communications between the first UE and the network entity upon satisfaction of the condition, and select a candidate UE of the one or more candidate UEs to establish a second link between the first UE and the candidate UE based on the configuration and determining that the condition associated with channel access is satisfied.

Another apparatus for wireless communication at a first UE is described. The apparatus may include means for communicating with a network entity over a communication path including a first link between the first UE and a second UE, the second UE configured to relay communications between the first UE and the network entity, means for receiving a control message including a configuration for modifying the communication path based on a condition associated with channel access, where the configuration indicates one or more candidate UEs for relaying the communications between the first UE and the network entity upon satisfaction of the condition, and means for selecting a candidate UE of the one or more candidate UEs to establish a second link between the first UE and the candidate UE based on the configuration and determining that the condition associated with channel access is satisfied.

A non-transitory computer-readable medium storing code for wireless communication at a first UE is described. The code may include instructions executable by a processor to communicate with a network entity over a communication path including a first link between the first UE and a second UE, the second UE configured to relay communications between the first UE and the network entity, receive a control message including a configuration for modifying the communication path based on a condition associated with channel access, where the configuration indicates one or more candidate UEs for relaying the communications between the first UE and the network entity upon satisfaction of the condition, and select a candidate UE of the one or more candidate UEs to establish a second link between the first UE and the candidate UE based on the configuration and determining that the condition associated with channel access is satisfied.

Some examples of the method, apparatuses, and non-transitory computer-readable medium described herein may further include operations, features, means, or instructions for receiving, from the second UE, a second control message based on a quantity of failures associated with channel access of the first link, where selecting the candidate UE may be further based on the control message.

Some examples of the method, apparatuses, and non-transitory computer-readable medium described herein may further include operations, features, means, or instructions for initiating a random access procedure associated with establishing or reestablishing a third link between the first UE and the network entity based on the configuration for modifying the communication path.

Some examples of the method, apparatuses, and non-transitory computer-readable medium described herein may further include operations, features, means, or instructions for determining a quantity of failures associated with channel access of the first link within a time window and indicating to upper layers of a communication stack the quantity of failures based on determining that the quantity of failures satisfies a threshold, where the condition includes the quantity of failures satisfying the threshold.

Some examples of the method, apparatuses, and non-transitory computer-readable medium described herein may further include operations, features, means, or instructions for determining whether a failure associated with channel access may have occurred on each subchannel of a set of subchannels associated with the first link, where selecting the candidate UE of the one or more candidate UEs may be further based on determining that a respective failure associated with channel access may have occurred on each subchannel of the set of subchannels.

Some examples of the method, apparatuses, and non-transitory computer-readable medium described herein may further include operations, features, means, or instructions for determining whether a failure associated with channel access may have occurred with each candidate UE of the one or more candidate UEs based on determining a second failure associated with a third link between the first UE and the network entity, where selecting the candidate UE of the one or more candidate UEs may be further based on determining that the failure may have not occurred with the candidate UE.

Some examples of the method, apparatuses, and non-transitory computer-readable medium described herein may further include operations, features, means, or instructions for transmitting, to a third UE, a second control message indicating to perform a relay selection procedure, where the first UE may be configured to relay communications between the third UE and the network entity.

Some examples of the method, apparatuses, and non-transitory computer-readable medium described herein may further include operations, features, means, or instructions for determining a channel access failure associated with the first link or a third link between the first UE and the network entity and activating packet data convergence protocol duplication for the first link, the second link, the third link, or any combination thereof, based on the configuration.

A method for wireless communication at a first UE is described. The method may include communicating with a network entity over a communication path including a first link between the first UE and a second UE, the second UE configured to relay communications between the first UE and the network entity, receiving a control message including a configuration for modifying the communication path based on a condition associated with a second link between the second UE and the network entity, detecting the condition based on a performance indication of the second link, and modifying the communication path based on detecting the condition.

An apparatus for wireless communication at a first UE is described. The apparatus may include a processor, memory coupled with the processor, and instructions stored in the memory. The instructions may be executable by the processor to cause the apparatus to communicate with a network entity over a communication path including a first link between the first UE and a second UE, the second UE configured to relay communications between the first UE and the network entity, receive a control message including a configuration for modifying the communication path based on a condition associated with a second link between the second UE and the network entity, detect the condition based on a performance indication of the second link, and modify the communication path based on detecting the condition.

Another apparatus for wireless communication at a first UE is described. The apparatus may include means for communicating with a network entity over a communication path including a first link between the first UE and a second UE, the second UE configured to relay communications between the first UE and the network entity, means for receiving a control message including a configuration for modifying the communication path based on a condition associated with a second link between the second UE and the network entity, means for detecting the condition based on a performance indication of the second link, and means for modifying the communication path based on detecting the condition.

A non-transitory computer-readable medium storing code for wireless communication at a first UE is described. The code may include instructions executable by a processor to communicate with a network entity over a communication path including a first link between the first UE and a second UE, the second UE configured to relay communications between the first UE and the network entity, receive a control message including a configuration for modifying the communication path based on a condition associated with a second link between the second UE and the network entity, detect the condition based on a performance indication of the second link, and modify the communication path based on detecting the condition.

In some examples of the method, apparatuses, and non-transitory computer-readable medium described herein, modifying the communication path may include operations, features, means, or instructions for modifying the communication path to include a third link between the first UE and the network entity or a fourth link between the first UE and a third UE and a fifth link between the third UE and the network entity.

Some examples of the method, apparatuses, and non-transitory computer-readable medium described herein may further include operations, features, means, or instructions for receiving, from the second UE, a message including one or more parameters that indicate the performance indication of the second link, where the condition includes the performance indication satisfying a threshold associated with interference.

In some examples of the method, apparatuses, and non-transitory computer-readable medium described herein, the configuration for modifying the communication path may be further based on a second condition associated with a third link between the first UE and the network entity.

In some examples of the method, apparatuses, and non-transitory computer-readable medium described herein, the second condition includes a second performance indication of the third link satisfying a threshold associated with interference.

In some examples of the method, apparatuses, and non-transitory computer-readable medium described herein, the configuration for modifying the communication path may be further based on a second condition associated with a third link between the first UE and a third UE, the second condition includes a second performance indication of the third link satisfying a threshold associated with interference.

A method for wireless communication at a first UE is described. The method may include communicating with a network entity over a communication path including a first link between the first UE and the network entity, receiving a control message including a configuration for modifying the communication path based on a condition associated with the first link, where the configuration indicates one or more candidate UEs for relaying the communications between the first UE and the network entity upon satisfaction of the condition, detecting the condition based on a performance indication of the first link, and modifying the communication path based on detecting the condition.

An apparatus for wireless communication at a first UE is described. The apparatus may include a processor, memory coupled with the processor, and instructions stored in the memory. The instructions may be executable by the processor to cause the apparatus to communicate with a network entity over a communication path including a first link between the first UE and the network entity, receive a control message including a configuration for modifying the communication path based on a condition associated with the first link, where the configuration indicates one or more candidate UEs for relaying the communications between the first UE and the network entity upon satisfaction of the condition, detect the condition based on a performance indication of the first link, and modify the communication path based on detecting the condition.

Another apparatus for wireless communication at a first UE is described. The apparatus may include means for communicating with a network entity over a communication path including a first link between the first UE and the network entity, means for receiving a control message including a configuration for modifying the communication path based on a condition associated with the first link, where the configuration indicates one or more candidate UEs for relaying the communications between the first UE and the network entity upon satisfaction of the condition, means for detecting the condition based on a performance indication of the first link, and means for modifying the communication path based on detecting the condition.

A non-transitory computer-readable medium storing code for wireless communication at a first UE is described. The code may include instructions executable by a processor to communicate with a network entity over a communication path including a first link between the first UE and the network entity, receive a control message including a configuration for modifying the communication path based on a condition associated with the first link, where the configuration indicates one or more candidate UEs for relaying the communications between the first UE and the network entity upon satisfaction of the condition, detect the condition based on a performance indication of the first link, and modify the communication path based on detecting the condition.

In some examples of the method, apparatuses, and non-transitory computer-readable medium described herein, modifying the communication path may include operations, features, means, or instructions for modifying the communication path to include a second link between the first UE and a second UE configured to relay communications between the first UE and the network entity.

Some examples of the method, apparatuses, and non-transitory computer-readable medium described herein may further include operations, features, means, or instructions for receiving, from the network entity, a message including one or more parameters that indicate the performance indication of the first link, where the condition includes the performance indication satisfying a threshold associated with interference.

In some examples of the method, apparatuses, and non-transitory computer-readable medium described herein, the configuration for modifying the communication path may be further based on a second condition associated with a second link between the first UE and one or more other UEs, the second condition including a second performance indication of the second link satisfying a threshold associated with interference.

### BRIEF DESCRIPTION OF THE DRAWINGS

FIGS. 1 and 2 illustrate examples of wireless communications systems that support sidelink unlicensed channel relay selection in accordance with one or more aspects of the present disclosure.

FIGS. 3 and 4 illustrate examples of process flows that support sidelink unlicensed channel relay selection in accordance with one or more aspects of the present disclosure.

FIGS. 5 and 6 show block diagrams of devices that support sidelink unlicensed channel relay selection in accordance with one or more aspects of the present disclosure.

FIG. 7 shows a block diagram of a communications manager that supports sidelink unlicensed channel relay selection in accordance with one or more aspects of the present disclosure.

FIG. 8 shows a diagram of a system including a device that supports sidelink unlicensed channel relay selection in accordance with one or more aspects of the present disclosure.

FIGS. 9 through 12 show flowcharts illustrating methods that support sidelink unlicensed channel relay selection in accordance with one or more aspects of the present disclosure.

### DETAILED DESCRIPTION

Some wireless communications systems may support sidelink relay communications. For example, a communication path between a first user equipment (UE) (e.g., a remote UE) and a network entity may include a first link between the first UE and a second UE (e.g., a relay UE) configured to relay communications between the first UE and the network entity and a second link between the second UE and the network entity. Some wireless communications procedures may include selection (e.g., selection, reselection) procedures associated with determining the communication path between the first UE and the network entity. For example, the procedure may include determining which, if any, relay UE to utilize and the links between the various wireless devices. In some cases, the selection procedures may be related to communication links of a licensed spectrum (e.g., licensed band). However, some communication paths may include links of an unlicensed spectrum. To support links of the unlicensed spectrum, the selection procedure for relay UEs may be updated.

The techniques described herein provide for updated relay selection procedures associated with the unlicensed channel, which may result in more efficient utilization of resources and increased data rate. For example, a first UE (e.g., a remote UE) may determine to perform a relay selection procedure and receive respective messages (e.g., relay discovery messages) from one or more second UEs (e.g., relay UEs) including one or more parameters (e.g., parameters associated with the unlicensed channel) for selecting a second UE to relay communications between the first UE and a network entity. The first UE may determine that respective parameters satisfy a threshold (e.g., a performance threshold) and select the second UE associated with the respective parameters. In some cases, the first UE may receive a control message prior to performing the relay selection procedure. The control message may include a configuration for modifying the communication path that includes an indication of one or more candidate UEs for relaying communications between the first UE and the network entity. In some examples, the configuration may indicate a condition associated with a link between a relay UE and the network entity or a condition associated with a link between the UE and the network entity (e.g., without a relay UE). The first UE may detect the condition (e.g., a measurement associated with channel access satisfying a threshold) and modify the communication path based on detecting the condition.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to sidelink unlicensed channel relay selection.

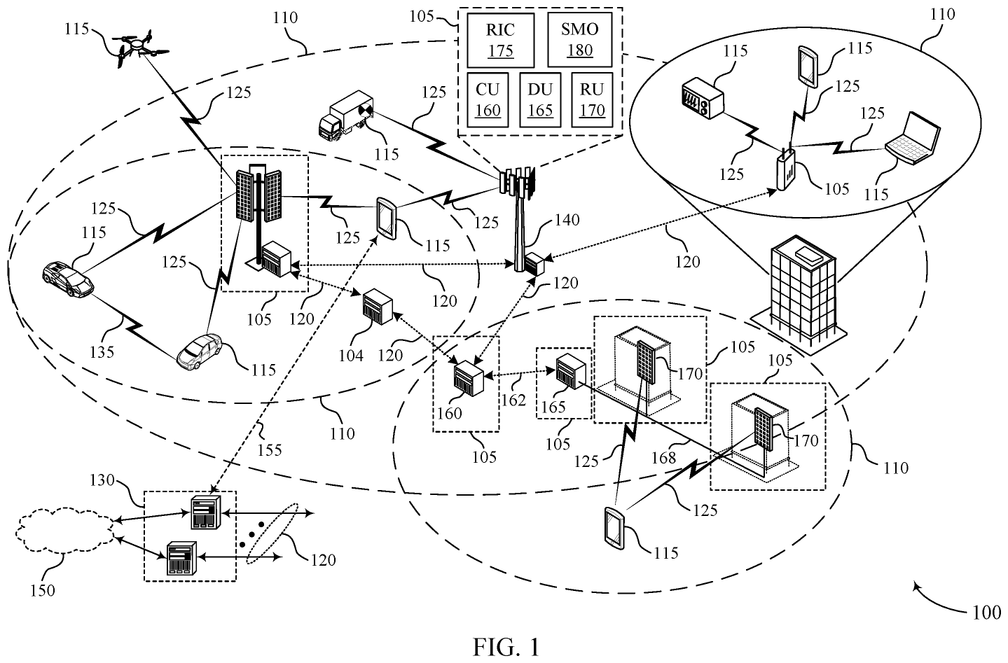

FIG. 1 illustrates an example of a wireless communications system 100 that supports sidelink unlicensed channel relay selection in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support sidelink unlicensed channel relay selection as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N f may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N f) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing (e.g., listen-before-talk (LBT) procedures) for collision detection and avoidance (e.g., to ensure a frequency channel is clear before transmitting data). In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, sidelink enhancement scenarios may be considered. For example, a scenario may include supporting sidelink on unlicensed spectrum for both mode 1 and mode 2, where Uu operation for mode 1 is limited to licensed spectrum. In mode 1, the network indicates the resources to be used for transmission by the sidelink UE, including a resource pool and the resources within the resource pool. In mode 2, the UE selects a resource pool and the resources from the resource pool for transmission. The scenario may include evaluating methodology for sidelink operation on unlicensed spectrum in frequency range one (FR1) (e.g., 5 GHz and 6 GHz), frequency range two (FR2) (e.g., bands above 24 GHz), or both, where a single active connection to a network entity (e.g., via Uu or via a single L2 or L3 relay UE) may be available at any given time (without mobility between relays). The scenario may include a Uu connection that is licensed with either a remote or relay UE in mode 2 or a remote and/or relay UE in mode 1, or a Uu connection that is unlicensed with a remote or relay UE in mode 2. The scenario may include a sidelink channel access mechanism for unlicensed spectrum based on regional regulation requirement similar to channel success schemes from NR-U (e.g., reuse previous resource allocation mechanisms as much as possible). Some NR sidelink physical channel structures and procedures to operate on unlicensed spectrum may change.

In some cases, the wireless communications system 100 may support sidelink relay communications. The sidelink relay communications may include various communication links, including links associated with licensed and unlicensed spectrum bands. For example, a communication path between a first UE 115 (e.g., a remote UE) and a network entity 105 may include various links associated with the different spectrum bands. A first scenario may include an unlicensed PC5 link between the first UE 115 and a second UE 115 (e.g., a remote UE) and a licensed Uu link between the second UE 115 and the network entity 105. A second scenario may include an unlicensed PC5 link between the first UE 115 and the second UE 115 and an unlicensed Uu link between the second UE 115 and the network entity 105. A third scenario may include multiple relay UEs 115 such that there are multiple communication paths between the first UE and the network entity (e.g., a direct link between the first UE 115 and the network entity 105, a path through a first relay UE 115, and a path through a second relay UE 115). The communication paths may include various links associated with an unlicensed link, a licensed link, or both. A fourth scenario may be similar to the third scenario but including a UE-to-UE (U2U) communication path (e.g., including source, relay, and destination UEs).

In some examples, the wireless communications system 100 may utilize sidelink over unlicensed spectrum to increase data rate. Some commercial use cases may utilize data rates in excess of what is possible through the licensed spectrum alone. For example, sensor information (e.g., video) sharing between vehicles (e.g., in V2X) with a high degree of driving automation may utilize high data rates. Increased data rate may be achieved with the support of sidelink carrier aggregation and sidelink over unlicensed spectrum. Further, by enhancing the FR2 sidelink operation, increased data rates may be more efficiently supported on FR2. While the support of new carrier frequencies and larger bandwidths may improve data rate, an additional benefit may be making the sidelink more applicable for a wider range of applications. More specifically, with the support of unlicensed spectrum and the enhancement in FR2, sidelink may be better implemented in commercial devices as utilization of the ITS band is limited to ITS safety related applications.

Additionally, a V2X deployment scenario where both LTE V2X and NR V2X devices are to coexist in the same frequency channel may be considered. For the two different types of devices to coexist while using a common carrier frequency, a mechanism to efficiently utilize resource allocation by the two technologies (e.g., without negatively impacting the operation of each technology) may be used.

In some cases, utilizing the unlicensed channel may include carrier sensing for collision detection and avoidance. For example, the UE 115 may employ an LBT procedure that includes listening to an unlicensed channel to ensure that the channel is clear of other traffic before transmitting data. If the channel is busy (e.g., other UEs are transmitting on this channel) then the UE 115 may experience an LBT failure (e.g., a failure to transmit on this channel as it is busy).

The techniques described herein provide for updated relay selection procedures associated with the unlicensed channel, which may allow for procedures associated with relay reselection (e.g., reacting to LBT failures on an unlicensed LBT connection), measurement reporting, and path switching. For example, a first UE 115 (e.g., a remote UE) may determine to perform a relay selection procedure and receive respective messages (e.g., relay discovery messages) from one or more second UEs 115 (e.g., relay UEs) including one or more parameters (e.g., parameters associated with the unlicensed channel) for selecting a second UE 115 to relay communications between the first UE 115 and a network entity 105. The first UE 115 may determine that respective parameters satisfy a threshold (e.g., a performance threshold) and select the second UE 115 associated with the respective parameters. In some cases, the first UE 115 may receive a control message prior to performing the relay selection procedure. The control message may include a configuration for modifying the communication path that includes an indication of one or more candidate UEs 115 for relaying communications between the first UE 115 and the network entity 105. In some examples, the configuration may indicate a condition associated with a link between a relay UE 115 and the network entity 105 or a condition associated with a link between the first UE 115 and the network entity 105 (e.g., without a relay UE). The first UE 115 may detect the condition (e.g., a measurement associated with channel access satisfying a threshold) and modify the communication path based on detecting the condition.

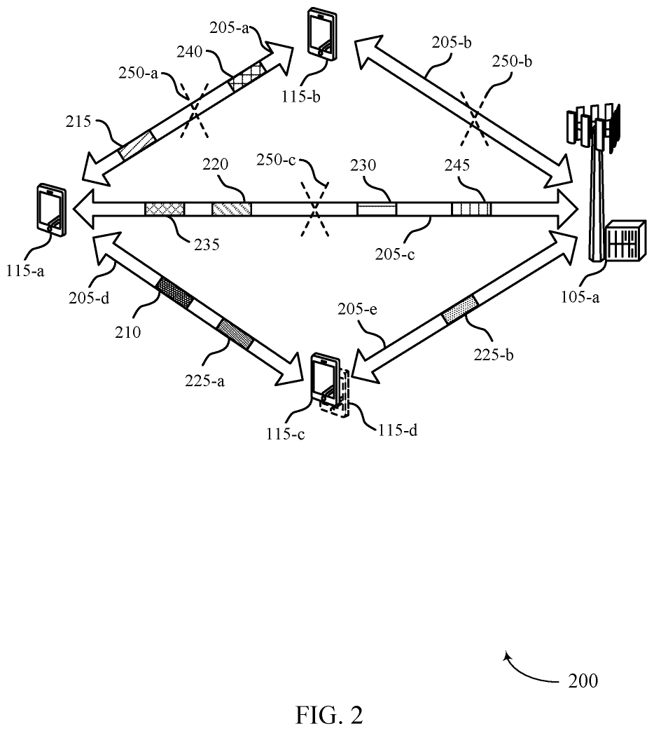

FIG. 2 illustrates an example of a wireless communications system 200 that supports sidelink unlicensed channel relay selection in accordance with one or more aspects of the present disclosure. In some examples, the wireless communications system 200 may implement aspects of the wireless communications system 100. For example, the wireless communications system 200 may include a UE 115-a, a UE 115-b, and optionally a UE 115-c and/or a UE 115-d, as well as a network entity 105-a, which may be examples of a UE 115 and a network entity 105, as described herein with reference to FIG. 1. In some cases, the UE 115-a may represent an example of a remote UE 115, and the UEs 115-b, 115-c, and 115-d may represent relay UEs 115, where the UE 115-b may be an active relay UE and the UEs 115-c and 115-d may be potential (e.g., candidate) relay UEs. The relay UEs may be configured to relay communications between the UE 115-a and the network entity 105-a.

The wireless communications system 200 may represent various communications paths between the UE 115-a and the network entity 105-a. For example, the UE 115-a may be directly connected with the network entity 105-a via a link 205-c (e.g., a direct link, Uu link), the UE 115-a may be indirectly connected with the network entity 105-a via a first link 205-a between the UE 115-a and the UE 115-b and a second link 205-b between the UE 115-b and the network entity 105-a, or both. Some wireless communications systems may include selection procedures for determining a licensed spectrum communication path between the UE 115-a and the network entity 105-a. However, some communication paths may include links of an unlicensed spectrum. For example, the links 205-a, 205-b, 205-c, 205-d, and 205-e may be unlicensed, licensed, or a combination thereof. In some cases, the links 205-a and 205-d (e.g., sidelink PC5 links) may be unlicensed. To support sidelink unlicensed channel selection procedures, the techniques described herein provide for updated relay selection procedures associated with relay selection (e.g., reselection), measurement reporting, and path switching (e.g., service continuity), utilizing links of the unlicensed spectrum.

In some cases, for relay selection, the UE 115-a may determine multiple candidate UEs for relaying communications to the network entity 105-a as part of a relay selection procedure. For example, the UE 115-c and the UE 115-d may be candidate UEs (e.g., other UEs). The UEs 115-c and 115-d may broadcast messages 210 (e.g., discovery messages) such that the UE 115-a may discover the UEs 115-c and 115-d as candidate UEs. In some cases, the discovery messages may include one or more parameters associated with channel access that the UE 115-a may use to determine which candidate UE to select for relaying communications with the network entity 105-a. For example, the parameters may include an LBT counter, a channel busy ratio (CBR) value, a likelihood of failure of an LBT procedure associated with the link 205-a or the link 205-b, a combination of a likelihood of failure associated with a first link of a UE-to-network (U2N) communication path (e.g., the link 205-a or the link 205-b) and a likelihood of failure associated with a second link of the U2N communication path (e.g., the link 205-d or the link 205-e), or any combination thereof.

In some cases, the LBT counter may include an average of LBT failures associated with other relay links between the respective candidate UE and other remote UEs. For example, the UE 115-c may be configured as a relay UE for multiple other UEs 115. The communication links between the UE 115-c and the multiple other remote UEs 115 may each be associated with a quantity of failures (e.g., LBT failures). For example, the UE 115-c may maintain a quantity (e.g., a counter) of how many LBT failures have occurred, a percentage of LBT failures (e.g., vs successes), an LBT failure rate, or a combination thereof, for each remote UE 115 that the UE 115-c is configured to relay for. The UE 115-c may broadcast a cumulative value (e.g., via the message 210) of an average of the respective quantity (e.g., percentage, rate, and the like) of failures for each communication link. In some cases, the cumulative value may be an LBT COUNTER value average. In some implementations, the UE 115-c may not broadcast the message 210 based on determining an LBT counter value that satisfies (e.g., is higher than) a threshold value.

In some examples, the CBR value (e.g., a received signal strength indicator (RSSI) measurement) may be associated with interference measured at the UE 115-a. For example, the UE 115-a may measure a combination of intra-radio access technology (RAT) interference (e.g., interference from other sidelink communications), inter-RAT interference (e.g., interference from other wireless communications like Bluetooth, Wi-Fi, and the like). In some cases, the CBR value may be the combination of the inter-RAT and intra-RAT interferences. In some implementations, the UE 115-c may combine a CBR value associated with the link 205-e (e.g., a Uu CBR value) and broadcast the message 210 including a total congestion (e.g., CBR) value associated with the link 205-d (e.g., a PC5 link) and the link 205-e.

In some cases, the likelihood of failure may be an approximation of a probability of LBT failure between the UE 115-a and the UE 115-c (or any remote UE). For example, the UE 115-c may determine the likelihood based on a measured inter-RAT interference, a measured intra-RAT interference, beam information (e.g., spatial information), previous LBT failure events, or the like. In some implementations, the UE 115-c may combine a first likelihood of failure associated with the link 205-d and a second likelihood of failure associated with the link 205-e. For example, the UE 115-c may average the first and second likelihoods of failure, or determine the combined likelihood of failure according to a weighting function. The message 210 may include the combination (e.g., a combination of PC5 and Uu LBT failure likelihood).

In some examples, the UE 115-a may select a relay UE of the candidate UEs for relaying communications between the UE 115-a and the network entity 105-a based on the one or more parameters included in the message 210. For example, the UE 115-a may receive a respective messages 210 from both the UE 115-c and the UE 115-d. In some examples, the UE 115-a may determine that the LBT counter value associated with the UE 115-c is better than (e.g., indicates a lower intra-RAT or inter-RAT interference, satisfies reference signal receive power (RSRP) conditions, satisfies other channel conditions) the LBT counter value associated with the UE 115-d. In some cases, the UE 115-a may determine that the CBR value associated with the UE 115-c is better than (e.g., a lower CBR value, satisfies other channel conditions) the CBR value associated with the UE 115-d. A lower CBR value may indicate a higher probability of avoiding LBT failure and performing traffic steering (e.g., avoiding relay UEs with high interference, load, or both). In some cases, the UE 115-a may determine that the LBT likelihood (e.g., the combination of LBT likelihoods for the entire communication path) associated with the UE 115-c is better than (e.g., is less than, is greater than, satisfies other channel conditions) the LBT likelihood associated with the UE 115-d. Based on one or more of these determinations, the UE 115-a may select the UE 115-c as a relay UE.

In some examples, the UE 115-a may perform a relay reselection procedure. For example, the UE 115-a may be in wireless communication with the UE 115-b. In some cases, the UE 115-a may trigger the relay reselection procedure based on determining that a sidelink measurement associated with the multiple candidate UEs (e.g., the UE 115-c and the UE 115-d) satisfies a first threshold.

In some cases, the UE 115-a may trigger the relay reselection procedure based on determining a link deterioration or failure. For example, the UE 115-a may determine that a sidelink RSRP value is less (e.g., including by a minimum hysteresis value) than a minimum received RSRP level threshold (e.g., q−RxLevMin). In some examples, the UE 115-a may determine a failure 250-a (e.g., a radio link failure (RLF)) associated with the link 205-a and trigger the relay reselection. In some examples, the UE 115-a may receive, from the UE 115-b, a message 215 (e.g., a failure message) indicating one or more failures 250-b associated with the link 205-b within a time duration (e.g., a time window, persistent failures). For example, the UE 115-b may detect persistent LBT failures on the link 205-b and transmit, to the UE 115-a, a PC5 RRC notification message, a MAC CE notification message, or both, indicating the LBT failures. The UE 115-a may determine whether to release or keep the link 205-a (e.g., a serving PC5 link) based on the LBT failures. The UE 115-a releasing the link 205-a may trigger an L2 or L3 release procedure.

In some examples, the UE 115-a may trigger the relay reselection procedure based on determining a quantity of failures associated with the link 205-a within a time duration satisfying a threshold. For example, the UE 115-a may determine that persistent LBT failures associated with the link 205-a within a window duration satisfy a max failure quantity (e.g., LBT_{COUNTER}≥lbt-FailureInstanceMaxCount within lbt-FailureDetectionTimer duration). The consistent LBT failure is indicated to upper layers (e.g., layers of a communication protocol stack) and the UE 115-a may store an indication (e.g., an identification associated with the UE 115-b, a table code associated with the UE 115-b, and the like) of the link 205-a such that the UE 115-a may select another relay UE (e.g., the UE 115-c) over the UE 115-b during the relay reselection procedure based on the consistent LBT failures (e.g., previous failures).

In some cases, the relay reselection procedure may be similar to the selection procedure. For example, the UE 115-a may receive respective messages 210 broadcast from the UE 115-c and the UE 115-d (the UE 115-a may ignore a broadcast from the UE 115-b based on the stored indication of failure). The UE 115-a may select the UE 115-c over the UE 115-d based on one or more parameters signaled by the respective message 210, channel strength, and the like. The UE 115-a may continue communication with the network entity 105-a via the UE 115-c based on selecting the UE 115-c for relaying the communications.

In some cases, the UE 115-a may determine a channel access failure (e.g., failure 250-a, failure 250-c) and activate PDCP duplication for the link 205-a, the link 205-b, the link 205-c, the link 205-d, the link 205-e, or any combination thereof based on the control message 235 (e.g., a configuration indicated by the control message 235). For example, the UE 115-a may be configured (e.g., per data radio bearer (DRB) at the PDCP level), via the control message 235, to activate multipath PDCP based on receiving an indication of LBT failure on the current path (e.g., a direct path, an indirect path). The PDCP may be duplicated over a direct Uu path, an L2 relay path, multiple L2 relay paths with or without an anchor Uu path, or any combination thereof. In some cases, the PDCP duplication may be triggered based on receiving HARQ feedback.

In some implementations, the UE 115-a may transmit a message 225-a to the UE 115-c. For example, the UE 115-a may be in wireless communication with the UE 115-c and transmit the message 225-a (e.g., a measurement report, a sidelink measurement report, a CBR measurement report, a control message) to report one or more parameters (e.g., LBT counter value, CBR value, sidelink RSRP, identification of the UE 115-c, source L2 identification, serving cell identification, and the like) to the network entity 105-a. The UE 115-c may then relay the message 225-b to the network entity 105-a. In some cases, the UE 115-a may transmit the message 225-a directly to the network entity 105-a via the link 205-c. In some cases, the UE 115-c may transmit the message 225-b including the parameters regardless of receiving the message 225-a.

In some implementations, the UE 115-a may receive a message 220 (e.g., a request, a control message) from the network entity 105-a (e.g., via the link 205-c or via the UE 115-c relaying the transmission). The message 220 may indicate (e.g., request) to the UE 115-a to transmit the message 225-a. For example, the network entity 105-a may transmit the message 220 (e.g., periodically, non-periodically, when considering a path switch, on-demand to assess different relaying capabilities) to understand PC5 link conditions (e.g., the link 205-d) and determine quality of service (QoS) configuration. The network entity 105-a may determine remote UE (e.g., UE 115-a) inter-RAT or intra-RAT interference, PC5 link LBT failure likelihood between the UE 115-a and the UE 115-c, which candidate relay UEs (e.g., the UE 115-b, the UE 115-d) have high interference, and the like, based on the message 225-a. In some cases, the network entity 105-a may estimate the likelihood of failure of every scheduled transmission (e.g., for mode 1 scheduling) based on the message 225-a. In some examples, the network entity 105-a may determine a communication path modification (e.g., a path switch) based on the message 225-a, other messages from candidate UEs, or both. The UE 115-a may receive an indication 230 to perform the communication path modification and determine to select a relay UE based on the indication 230.

In some cases, the UE 115-a may communicate with the network entity 105-a over a communication path comprising the link 205-a and the link 205-b, the UE 115-b configured to relay communications between the UE 115-a and the network entity 105-a. The UE 115-a may receive (e.g., via the link 205-c, via the link 205-a) a control message 235 including a configuration for modifying the communication path based on one or more conditions (e.g., events) associated with the link 205-b. For example, the configuration may trigger a path switch from the UE 115-b to another relay UE (e.g., the UE 115-c or the UE 115-d) or from the UE 115-b to a direct path (e.g., Uu link, the link 205-c) based on the conditions. For example, the UE 115-a may switch to a direct Uu path, a PC5 relay path, between two PC5 relay paths, or any combination thereof.

In some cases, the UE 115-a may detect the condition based on a performance indication of the link 205-b (e.g., a serving relay Uu connection). For example, the UE 115-a may receive a message 240 including one or more parameters that indicate the performance indication of the link 205-b. The UE 115-a may determine that the performance indication satisfies a first threshold associated with interference, therefore satisfying the condition. For example, the performance indication may indicate (e.g., via one or more parameters, an LBT counter value, a CBR value, an inter-RAT interference measurement value, Wi-Fi cumulative RSSI, and the like) that an inter-RAT interference value associated with the link 205-b satisfies the first threshold (e.g., is greater than, or greater than or equal to, an interference threshold).

In some examples, the configuration may include a second condition. For example, the second condition may be associated with the link 205-c (e.g., a Uu connection) between the UE 115-a and the network entity 105-a. The second condition may comprise a second performance indication of the link 205-c satisfying a second threshold associated with interference. For example, the second performance indication may indicate that an inter-RAT interference value associated with the link 205-c satisfies the second threshold (e.g., is less than, is less than or equal to, an interference threshold).

In some examples, the configuration may include a third condition. For example, the third condition may be associated with the link 205-e (e.g., a non-serving relay Uu connection) between the UE 115-c and the network entity 105-a. The third condition may comprise a third performance indication of the link 205-e satisfying a third threshold associated with interference. For example, the third performance indication may indicate that an inter-RAT interference value associated with the link 205-e satisfies the third threshold (e.g., is less than, is less than or equal to, an interference threshold).

In some cases, the UE 115-a may modify the communication path based on the first condition being satisfied, the second condition being satisfied, the third condition being satisfied, or any combination thereof. For example, in a first scenario, the UE 115-a may detect the first condition (e.g., via the message 240), and modify the communication path based on detecting the first condition being satisfied. In a second scenario, the UE 115-a may detect the first condition and the second condition being satisfied, and modify the communication path based on detecting the first condition and the second condition. In a third scenario, the UE 115-a may detect the first condition and the third condition being satisfied, and modify the communication path based on detecting the first condition and the second condition. In some cases, modifying the communication path may include establishing the link 205-c (e.g., direct path, Uu link) or the link 205-d and the link 205-e (e.g., an indirect path, relay communication path, PC5 and Uu links). The UE 115-a may receive a configuration that may enable path switching under the first scenario, the second scenario, or the third scenario, along with the applicable thresholds.

In some implementations, the UE 115-a may communicate with the network entity 105-a over a communication path comprising the link 205-c. The UE 115-a may receive (e.g., via the link 205-c) a control message 235 including a configuration for modifying the communication path based on one or more conditions associated with the link 205-c. For example, the configuration may trigger a path switch from the direct path (e.g., Uu link, the link 205-c) to a relay UE (e.g., UE 115-c or the UE 115-d). For example, the UE 115-a may switch to a PC5 relay path or between two PC5 relay paths.

In some cases, the UE 115-a may detect a fourth condition based on a performance indication of the link 205-c. For example, the UE 115-a may receive a message 245 including one or more parameters that indicate the performance indication of the link 205-c. The UE 115-a may determine that the performance indication satisfies a fourth threshold associated with interference, therefore satisfying the fourth condition. For example, the performance indication may indicate (e.g., via one or more parameters, an LBT counter value, a CBR value, an inter-RAT interference measurement value, Wi-Fi cumulative RSSI, and the like) that an inter-RAT interference value associated with the link 205-c satisfies the fourth threshold (e.g., is greater than, is greater than or equal to, an interference threshold).

In some examples, the configuration may include a fifth condition. For example, the fifth condition may be associated with the link 205-d, the link 205-e, or both. The fifth condition may comprise a second performance indication of the link 205-d, the link 205-e, or both, satisfying a fifth threshold associated with interference. For example, the second performance indication may indicate that an inter-RAT interference value associated with the link 205-d, the link 205-e, or both, satisfies the fifth threshold (e.g., is less than, is less than or equal to, an interference threshold).

In some cases, the UE 115-a may modify the communication path based on the fourth condition being satisfied, the fifth condition being satisfied, or both. For example, the UE 115-a may detect the fourth condition and fifth second condition (e.g., via the message 245) and modify the communication path to include the link 205-d or the link 205-e (e.g., an indirect path, relay communication path, PC5 and Uu links). The UE 115-a may receive a configuration that may enable path switching under the fourth condition, the fifth condition, or both, along with the applicable thresholds.

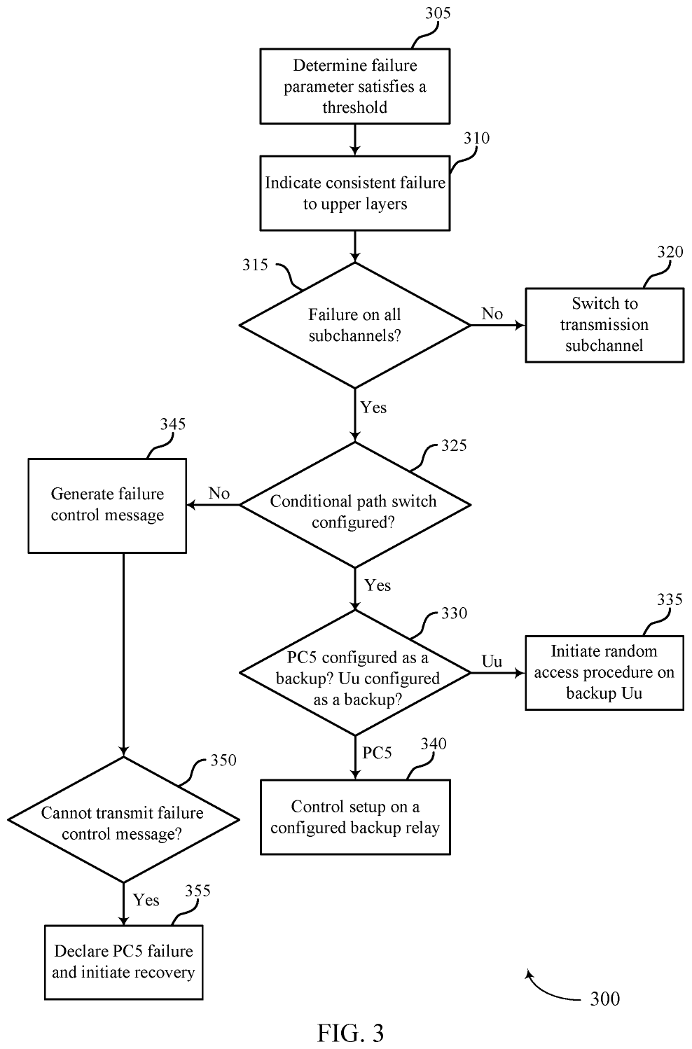

FIG. 3 illustrates an example of a process flow 300 that supports sidelink unlicensed channel relay selection in accordance with one or more aspects of the present disclosure. In some examples, the process flow 300 may implement or be implemented by aspects of the wireless communications systems 100 and 200 as described with reference to FIGS. 1 and 2. For example, aspects of the process flow 300 may be implemented by a UE 115 and a network entity 105, which may be respective examples of a remote UE 115, a relay UE 115, and a network entity 105-a, as described with reference to FIGS. 1 and 2. In some cases, a first UE 115 (e.g., a remote UE) may communicate with the network entity 105 over a communication path comprising a first link (e.g., link 205-a) between the first UE 115 and a second UE 115 (e.g., a relay UE) and a second link (e.g., link 205-b) between the second UE and the network entity 105, as described herein with reference to FIG. 2.

In some implementations, the first UE 115 may receive a first control message (e.g., message 235, RRC message) including a configuration. The configuration may indicate to modify the communication path (e.g., conditional path switch) based on a condition associated with channel access (e.g., detecting consistent LBT failure). The configuration may indicate one or more candidate UEs (e.g., candidate relay UEs) for relaying communications between the first UE 115 and the network entity 105 based on satisfaction of the condition. The first UE 115 may perform a selection procedure and select a candidate UE 115 (e.g., the UE 115-c) of the configured candidate UEs (e.g., the UE 115-c, the UE 115-d) to establish a third link (e.g., link 205-d) between the first UE 115 and the candidate UE 115, as described herein with reference to FIG. 2).

At 305, the first UE 115 may determine that one or more parameters satisfies a threshold. For example, the first UE 115 may determine a quantity of failures (e.g., an LBT counter value) associated with channel access of the first link within a time window (e.g., within lbt-FailureDetectionTimer duration). The first UE 115 may determine that the quantity of failures satisfies a maximum failure quantity threshold (LBT_{COUNTER}≥lbt-FailureInstanceMaxCount), as described herein with reference to FIG. 2. For example, the second UE 115 may transmit a second control message (e.g., a Uu MAC CE) to the network entity 105 to inform the network entity 105 of the LBT consistent failure (e.g., such that the network entity 105 may determine to trigger a path switch). The first UE 115 may receive a second control message (e.g., a PC5 MAC CE) from the second UE 115 to trigger a relay reselection.

At 310, the first UE 115 may indicate (e.g., report) the quantity of failures (e.g., consistent LBT failure) to the upper layers (e.g., upper layers of a communication protocol stack) based on the parameters (e.g., the LBT counter value). For example, the quantity of failures satisfying the threshold may satisfy the condition. The first UE 115 may then initiate the selection procedure. In some cases, the first UE 115 may attempt (e.g., perform, execute) one or more actions (e.g., aspects of the process flow 300) in sequence, such that the process flow 300 may be terminated (e.g., completed) if any of the actions are successful (e.g., recovery from the failure is complete). The process flow 300 may represent a type of relay selection (e.g., reselection) procedure.

At 315, the first UE 115 may determine whether a failure associated with channel access (e.g., LBT) has occurred on each subchannel of a set of subchannels associated with the first link. For example, at 320, the UE 115 may switch to a different transmission subchannel (e.g., resource set) that has not experienced a failure (e.g., within a time window). The transmission subchannel may be an LBT subchannel that is smaller than a bandwidth part granularity, allowing the first UE 115 to switch LBT subchannels based on consistent failure.

In some examples, the first UE 115 may determine that a respective failure associated with channel access has occurred on each subchannel of the set of subchannels. At 325, the first UE 115 may determine if path switching has been configured. If path switching is configured, at 330, the first UE 115 may determine if a candidate relay UE 115 is configured as a backup, a direct path (e.g., a Uu link, the link 205-c) is configured as a backup, or both. For example, at 335, the first UE 115 may initiate a random access procedure associated with establishing or reestablishing a fourth link (e.g., the link 205-c, Uu link) between the first UE 115 and the network entity 105 (e.g., autonomously without reporting the failure or receiving an additional reconfiguration message prior to initiating the random access procedure). At 340, the first UE 115 may connect to the designated backup relay UE 115 without restarting relay resection procedures (e.g., RRC reestablishment or setup on the configured backup relay). In some cases, the first UE 115 may attempt to connect to the set of candidate relay UEs (e.g., to mitigate consistent LBT failure). The first UE 115 may determine whether a failure associated with channel access (e.g., LBT) has occurred with each candidate UE of the configured UEs and select the designated backup relay UE 115 based on determining that a failure has not occurred with the backup relay UE 115. If the conditional switching fails (e.g., a failure has occurred with all candidate UEs) then the first UE 115 may declare a sidelink RLF and follow L2 or L3 relay recovery procedures.

In some implementations, if the first UE 115 is not configured with a conditional path switch, at 345, the first UE 115 may generate a failure control message. The failure control message may indicate a failure to the second UE 115. At 350, the first UE 115 may determine if it is possible to transmit the failure control message. For example, if the communication path is still connected (e.g., failure occurred but path is still alive, path is inconsistent, path is unreliable), the first UE 115 may transmit a control message (e.g., a MAC CE, an RRC) indicating LBT failure to the second UE 115. The second UE 115 may transmit another control message (e.g., a new MAC CE, a new RRC) to the network entity 105, indicating persistent LBT failure. The network entity 105 may trigger a path switch, indicate sidelink RLF failure, or both.

At 355, the first UE 115 may determine the it cannot transmit the failure message (e.g., the path is dead, path is inactive, unable to transmit on the path). Based on the determination, the first UE 115 may declare a PC5 failure and initiate a recovery process (e.g., a sidelink RLF recovery process).

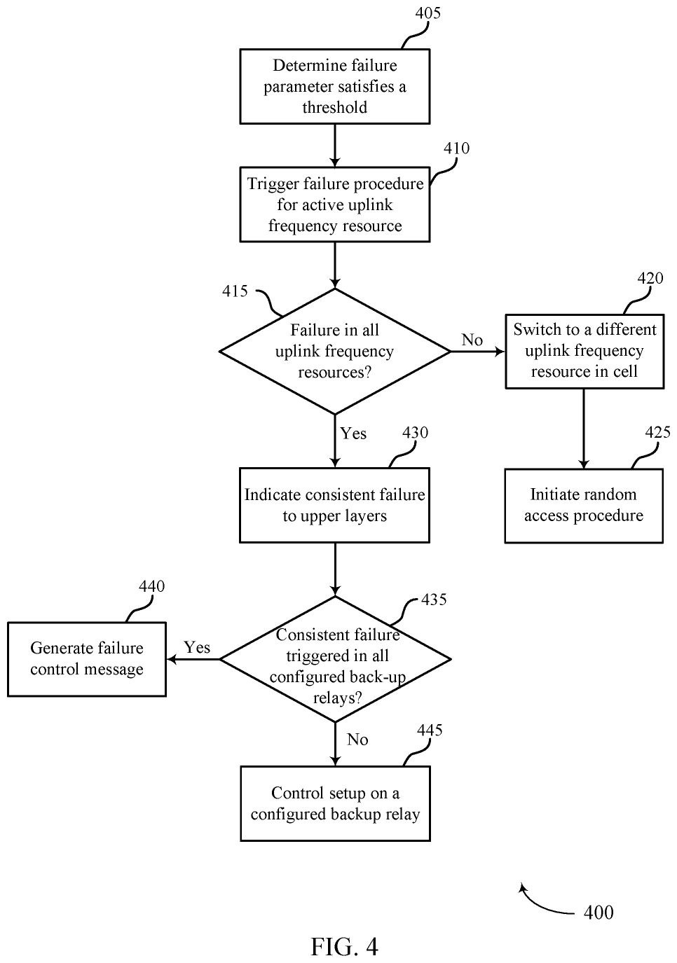

FIG. 4 illustrates an example of a process flow 400 that supports sidelink unlicensed channel relay selection in accordance with one or more aspects of the present disclosure. In some examples, the process flow 400 may implement or be implemented by aspects of the wireless communications systems 100 and 200 as described with reference to FIGS. 1 and 2. For example, aspects of the process flow 400 may be implemented by a UE 115 and a network entity 105, which may be respective examples of a remote UE 115, a relay UE 115, and a network entity 105-a, as described with reference to FIGS. 1 and 2. In some cases, a first UE 115 (e.g., a remote UE) may communicate with the network entity 105 over a communication path comprising a first link (e.g., link 205-a) between the first UE 115 and a second UE 115 (e.g., a relay UE) and a second link (e.g., link 205-b) between the second UE and the network entity 105, as described herein with reference to FIG. 2. In some examples, the actions of the process flow 400 may occur before or after transmitting a control message (e.g., MAC CE, RRC) indicating link failure (e.g., LBT failure) to the network entity 105.

In some implementations, the first UE 115 may receive a first control message (e.g., message 235, RRC message) including a configuration (e.g., lbt-FailureRecoveryConfig). The configuration may indicate to perform a conditional path switch to one of a set of candidate relay UEs (e.g., preconfigured relay UEs). The configuration may indicate to the first UE 115 to attempt the path switch using indicated bandwidth parts and backup relay UEs where LBT failure has not been declared. Additionally, or alternatively, the configuration may indicate to restart the relay selection (e.g., reselection) procedure to find a suitable relay UE (e.g., high RSRP, low LBT failure likelihood).

For example, at 405, the first UE 115 may determine that one or more parameters satisfies a threshold. For example, the first UE 115 may determine a quantity of failures (e.g., an LBT counter value) associated with channel access of the first link within a time window (e.g., within lbt-FailureDetectionTimer duration). The first UE 115 may determine that the quantity of failures satisfies a maximum failure quantity threshold (LBT_{COUNTER}≥lbt-FailureInstanceMaxCount), as described herein with reference to FIG. 2. The parameters satisfying the threshold may trigger, at 410, a failure procedure for active uplink frequency resources. For example, the active uplink bandwidth part in the serving cell (e.g., the serving cell associated with the network entity 105) may be triggered.

At 415, the first UE 115 may determine whether a failure associated with channel access (e.g., LBT) has occurred on each uplink frequency resource (e.g., configured uplink bandwidth parts) of a set of frequency resources. For example, at 420, the UE 115 may switch to the active uplink bandwidth part to a different uplink bandwidth part (e.g., an uplink bandwidth part on the same carrier in the serving cell) configured with physical random access channel (PRACH) occasions and that has not experienced consistent failures (e.g., a quantity of failures above a threshold within a time window). At 425, the first UE 115 may initiate a random access procedure using the different uplink bandwidth part.

In some examples, the first UE 115 may determine that a respective failure associated with channel access has occurred on each uplink frequency resource. At 430, the first UE 115 may indicate consistent LBT failure to upper layers (e.g., layers of a communication protocol stack). At 435, the first UE 115 may determine if consistent failure has been triggered in all configured candidate (e.g., backup) relay UEs. For example, at 445, the first UE 115 may determine a relay UE 115 (e.g., the UE 115-c) has not experienced LBT failure within a time duration and perform control setup with the relay UE 115 (e.g., RRC reestablishment or setup on a configured backup relay). At 440, the first UE 115 may determine that consistent failure has occurred with all the configured candidate relay UEs and generate a failure control message (e.g., instruct the multiplexing and assembly procedure to generate the LBT failure MAC CE).

In some cases, the first UE 115 may also be a relay UE for a third UE 115 (e.g., a remote UE). For example, the first UE 115 may be a remote UE for a first communication path and a relay UE for a second communication path. The first UE 115 may transmit, to the third UE 115, a second control message (e.g., a new MAC CE message, a new RRC message) indicating to perform a relay selection procedure (e.g., restart relay selection as only one hop paths may be configured).

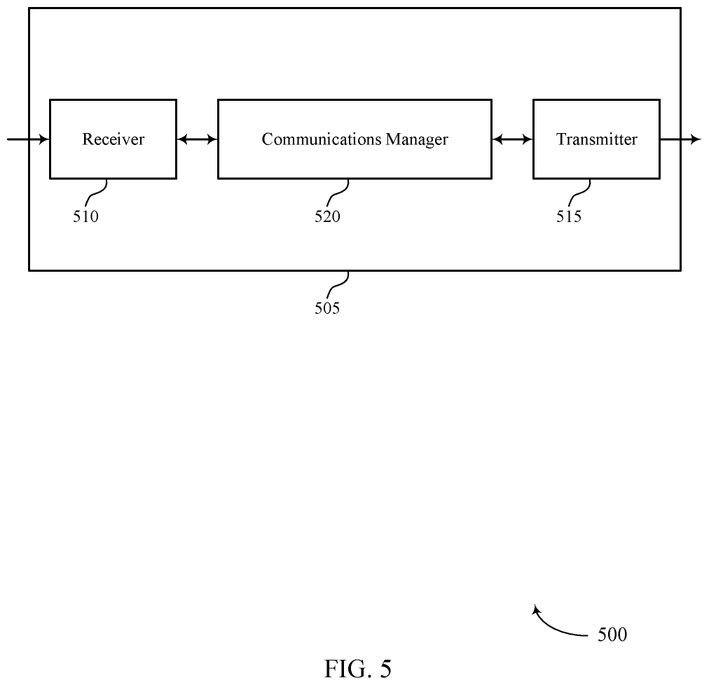

FIG. 5 shows a block diagram 500 of a device 505 that supports sidelink unlicensed channel relay selection in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to sidelink unlicensed channel relay selection). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to sidelink unlicensed channel relay selection). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of sidelink unlicensed channel relay selection as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a first UE in accordance with examples as disclosed herein. For example, the communications manager 520 may be configured as or otherwise support a means for receiving, from one or more other UEs based on determining that a sidelink measurement associated with the one or more other UEs satisfies a first threshold, a message including one or more parameters associated with channel access by the one or more other UEs, where the one or more other UEs are candidate UEs for relaying communications between the first UE and a network entity. The communications manager 520 may be configured as or otherwise support a means for selecting a second UE of the one or more other UEs for relaying communications between the first UE and the network entity based on the one or more parameters satisfying a second threshold. The communications manager 520 may be configured as or otherwise support a means for communicating with the network entity via the second UE based on selecting the second UE for relaying the communications.

Additionally, or alternatively, the communications manager 520 may support wireless communication at a first UE in accordance with examples as disclosed herein. For example, the communications manager 520 may be configured as or otherwise support a means for communicating with a network entity over a communication path including a first link between the first UE and a second UE, the second UE configured to relay communications between the first UE and the network entity. The communications manager 520 may be configured as or otherwise support a means for receiving a control message including a configuration for modifying the communication path based on a condition associated with channel access, where the configuration indicates one or more candidate UEs for relaying the communications between the first UE and the network entity upon satisfaction of the condition. The communications manager 520 may be configured as or otherwise support a means for selecting a candidate UE of the one or more candidate UEs to establish a second link between the first UE and the candidate UE based on the configuration and determining that the condition associated with channel access is satisfied.

Additionally, or alternatively, the communications manager 520 may support wireless communication at a first UE in accordance with examples as disclosed herein. For example, the communications manager 520 may be configured as or otherwise support a means for communicating with a network entity over a communication path including a first link between the first UE and a second UE, the second UE configured to relay communications between the first UE and the network entity. The communications manager 520 may be configured as or otherwise support a means for receiving a control message including a configuration for modifying the communication path based on a condition associated with a second link between the second UE and the network entity. The communications manager 520 may be configured as or otherwise support a means for detecting the condition based on a performance indication of the second link. The communications manager 520 may be configured as or otherwise support a means for modifying the communication path based on detecting the condition.

Additionally, or alternatively, the communications manager 520 may support wireless communication at a first UE in accordance with examples as disclosed herein. For example, the communications manager 520 may be configured as or otherwise support a means for communicating with a network entity over a communication path including a first link between the first UE and the network entity. The communications manager 520 may be configured as or otherwise support a means for receiving a control message including a configuration for modifying the communication path based on a condition associated with the first link, where the configuration indicates one or more candidate UEs for relaying the communications between the first UE and the network entity upon satisfaction of the condition. The communications manager 520 may be configured as or otherwise support a means for detecting the condition based on a performance indication of the first link. The communications manager 520 may be configured as or otherwise support a means for modifying the communication path based on detecting the condition.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, and more efficient utilization of communication resources.

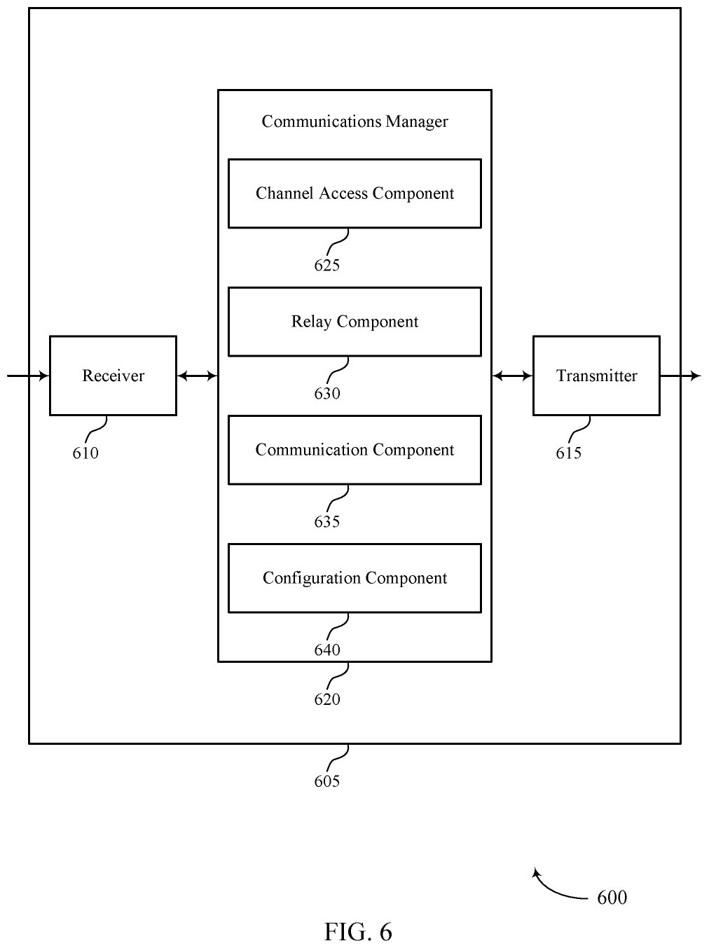

FIG. 6 shows a block diagram 600 of a device 605 that supports sidelink unlicensed channel relay selection in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to sidelink unlicensed channel relay selection). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to sidelink unlicensed channel relay selection). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of sidelink unlicensed channel relay selection as described herein. For example, the communications manager 620 may include a channel access component 625, a relay component 630, a communication component 635, a configuration component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first UE in accordance with examples as disclosed herein. The channel access component 625 may be configured as or otherwise support a means for receiving, from one or more other UEs based on determining that a sidelink measurement associated with the one or more other UEs satisfies a first threshold, a message including one or more parameters associated with channel access by the one or more other UEs, where the one or more other UEs are candidate UEs for relaying communications between the first UE and a network entity. The relay component 630 may be configured as or otherwise support a means for selecting a second UE of the one or more other UEs for relaying communications between the first UE and the network entity based on the one or more parameters satisfying a second threshold. The communication component 635 may be configured as or otherwise support a means for communicating with the network entity via the second UE based on selecting the second UE for relaying the communications.

Additionally, or alternatively, the communications manager 620 may support wireless communication at a first UE in accordance with examples as disclosed herein. The communication component 635 may be configured as or otherwise support a means for communicating with a network entity over a communication path including a first link between the first UE and a second UE, the second UE configured to relay communications between the first UE and the network entity. The configuration component 640 may be configured as or otherwise support a means for receiving a control message including a configuration for modifying the communication path based on a condition associated with channel access, where the configuration indicates one or more candidate UEs for relaying the communications between the first UE and the network entity upon satisfaction of the condition. The relay component 630 may be configured as or otherwise support a means for selecting a candidate UE of the one or more candidate UEs to establish a second link between the first UE and the candidate UE based on the configuration and determining that the condition associated with channel access is satisfied.

Additionally, or alternatively, the communications manager 620 may support wireless communication at a first UE in accordance with examples as disclosed herein. The communication component 635 may be configured as or otherwise support a means for communicating with a network entity over a communication path including a first link between the first UE and a second UE, the second UE configured to relay communications between the first UE and the network entity. The configuration component 640 may be configured as or otherwise support a means for receiving a control message including a configuration for modifying the communication path based on a condition associated with a second link between the second UE and the network entity. The channel access component 625 may be configured as or otherwise support a means for detecting the condition based on a performance indication of the second link. The relay component 630 may be configured as or otherwise support a means for modifying the communication path based on detecting the condition.

Additionally, or alternatively, the communications manager 620 may support wireless communication at a first UE in accordance with examples as disclosed herein. The communication component 635 may be configured as or otherwise support a means for communicating with a network entity over a communication path including a first link between the first UE and the network entity. The configuration component 640 may be configured as or otherwise support a means for receiving a control message including a configuration for modifying the communication path based on a condition associated with the first link, where the configuration indicates one or more candidate UEs for relaying the communications between the first UE and the network entity upon satisfaction of the condition. The channel access component 625 may be configured as or otherwise support a means for detecting the condition based on a performance indication of the first link. The relay component 630 may be configured as or otherwise support a means for modifying the communication path based on detecting the condition.

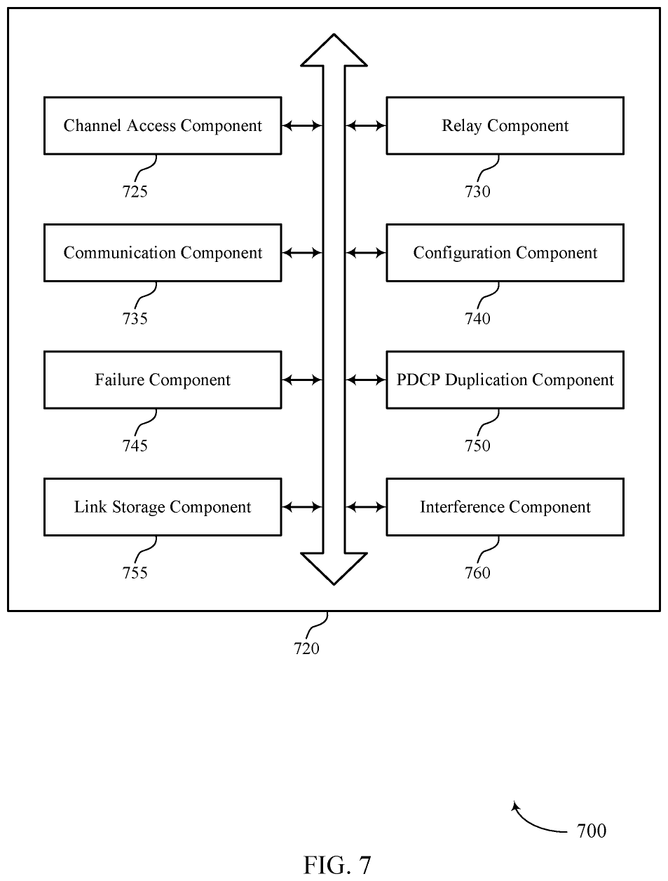

FIG. 7 shows a block diagram 700 of a communications manager 720 that supports sidelink unlicensed channel relay selection in accordance with one or more aspects of the present disclosure. The communications manager 720 may be an example of aspects of a communications manager 520, a communications manager 620, or both, as described herein. The communications manager 720, or various components thereof, may be an example of means for performing various aspects of sidelink unlicensed channel relay selection as described herein. For example, the communications manager 720 may include a channel access component 725, a relay component 730, a communication component 735, a configuration component 740, a failure component 745, a PDCP duplication component 750, a link storage component 755, an interference component 760, or any combination thereof. Each of these components may communicate, directly or indirectly, with one another (e.g., via one or more buses).

The communications manager 720 may support wireless communication at a first UE in accordance with examples as disclosed herein. The channel access component 725 may be configured as or otherwise support a means for receiving, from one or more other UEs based on determining that a sidelink measurement associated with the one or more other UEs satisfies a first threshold, a message including one or more parameters associated with channel access by the one or more other UEs, where the one or more other UEs are candidate UEs for relaying communications between the first UE and a network entity. The relay component 730 may be configured as or otherwise support a means for selecting a second UE of the one or more other UEs for relaying communications between the first UE and the network entity based on the one or more parameters satisfying a second threshold. The communication component 735 may be configured as or otherwise support a means for communicating with the network entity via the second UE based on selecting the second UE for relaying the communications.

In some examples, the failure component 745 may be configured as or otherwise support a means for determining a quantity of failures associated with a link between the first UE and a third UE within a time duration. In some examples, the failure component 745 may be configured as or otherwise support a means for determining that the quantity of failures satisfies a third threshold, where selecting the second UE for relaying communications is further based on the quantity of failures satisfying the third threshold.

In some examples, the link storage component 755 may be configured as or otherwise support a means for storing an indication of the link between the first UE and the third UE based on determining that the quantity of failures satisfies the third threshold, where selecting the second UE rather than the third UE for relaying communications between the first UE and the network entity is based on storing the indication of the link between the first UE and the third UE.

In some examples, the failure component 745 may be configured as or otherwise support a means for receiving, from a third UE configured to relay communications between the first UE and the network entity, a second message indicating one or more failures associated with a first link between the third UE and the network entity within a time duration. In some examples, the relay component 730 may be configured as or otherwise support a means for determining whether to release a second link between the first UE and the third UE based on the one or more failures.

In some examples, the channel access component 725 may be configured as or otherwise support a means for transmitting, to a third UE configured for relaying communications between the first UE and the network entity, a control message including the one or more parameters. In some examples, the relay component 730 may be configured as or otherwise support a means for receiving an indication to perform a communication path modification based on transmitting the control message, where selecting the second UE is further based on the indication.

In some examples, the channel access component 725 may be configured as or otherwise support a means for receiving a second message including a second indication to transmit the control message, where transmitting the control message is based on receiving the second message.

In some examples, the one or more parameters include a combination of a likelihood of failure associated with a first link between the first UE and the one or more other UEs and a likelihood of failure associated with a second link between the one or more other UEs and the network entity.

In some examples, the message is a discovery message associated with a relay selection procedure.

In some examples, the one or more parameters for reselection includes a LBT counter, a CBR value, a likelihood of failure of a LBT procedure associated with a link between the first UE and the second UE, or any combination thereof.

In some examples, the LBT counter includes an average of LBT failures associated with one or more links between a respective UE of the one or more other UEs and a respective third UE.

In some examples, the interference component 760 may be configured as or otherwise support a means for measuring interference at the first UE, where the CBR value is based at least in part on the measured interference.

Additionally, or alternatively, the communications manager 720 may support wireless communication at a first UE in accordance with examples as disclosed herein. In some examples, the communication component 735 may be configured as or otherwise support a means for communicating with a network entity over a communication path including a first link between the first UE and a second UE, the second UE configured to relay communications between the first UE and the network entity. The configuration component 740 may be configured as or otherwise support a means for receiving a control message including a configuration for modifying the communication path based on a condition associated with channel access, where the configuration indicates one or more candidate UEs for relaying the communications between the first UE and the network entity upon satisfaction of the condition. In some examples, the relay component 730 may be configured as or otherwise support a means for selecting a candidate UE of the one or more candidate UEs to establish a second link between the first UE and the candidate UE based on the configuration and determining that the condition associated with channel access is satisfied.

In some examples, the channel access component 725 may be configured as or otherwise support a means for receiving, from the second UE, a second control message based on a quantity of failures associated with channel access of the first link, where selecting the candidate UE is further based on the control message.

In some examples, the relay component 730 may be configured as or otherwise support a means for initiating a random access procedure associated with establishing or reestablishing a third link between the first UE and the network entity based on the configuration for modifying the communication path.

In some examples, the failure component 745 may be configured as or otherwise support a means for determining a quantity of failures associated with channel access of the first link within a time window. In some examples, the failure component 745 may be configured as or otherwise support a means for indicating to upper layers of a communication stack the quantity of failures based on determining that the quantity of failures satisfies a threshold, where the condition includes the quantity of failures satisfying the threshold.

In some examples, the channel access component 725 may be configured as or otherwise support a means for determining whether a failure associated with channel access has occurred on each subchannel of a set of subchannels associated with the first link, where selecting the candidate UE of the one or more candidate UEs is further based on determining that a respective failure associated with channel access has occurred on each subchannel of the set of subchannels.

In some examples, the channel access component 725 may be configured as or otherwise support a means for determining whether a failure associated with channel access has occurred with each candidate UE of the one or more candidate UEs based on determining a second failure associated with a third link between the first UE and the network entity, where selecting the candidate UE of the one or more candidate UEs is further based on determining that the failure has not occurred with the candidate UE.

In some examples, the relay component 730 may be configured as or otherwise support a means for transmitting, to a third UE, a second control message indicating to perform a relay selection procedure, where the first UE is configured to relay communications between the third UE and the network entity.

In some examples, the channel access component 725 may be configured as or otherwise support a means for determining a channel access failure associated with the first link or a third link between the first UE and the network entity. In some examples, the PDCP duplication component 750 may be configured as or otherwise support a means for activating PDCP duplication for the first link, the second link, the third link, or any combination thereof, based on the configuration.

Additionally, or alternatively, the communications manager 720 may support wireless communication at a first UE in accordance with examples as disclosed herein. In some examples, the communication component 735 may be configured as or otherwise support a means for communicating with a network entity over a communication path including a first link between the first UE and a second UE, the second UE configured to relay communications between the first UE and the network entity. In some examples, the configuration component 740 may be configured as or otherwise support a means for receiving a control message including a configuration for modifying the communication path based on a condition associated with a second link between the second UE and the network entity. In some examples, the channel access component 725 may be configured as or otherwise support a means for detecting the condition based on a performance indication of the second link. In some examples, the relay component 730 may be configured as or otherwise support a means for modifying the communication path based on detecting the condition.

In some examples, to support modifying the communication path, the relay component 730 may be configured as or otherwise support a means for modifying the communication path to include a third link between the first UE and the network entity or a fourth link between the first UE and a third UE and a fifth link between the third UE and the network entity.

In some examples, the channel access component 725 may be configured as or otherwise support a means for receiving, from the second UE, a message including one or more parameters that indicate the performance indication of the second link, where the condition includes the performance indication satisfying a threshold associated with interference.

In some examples, the configuration for modifying the communication path is further based on a second condition associated with a third link between the first UE and the network entity.

In some examples, the second condition includes a second performance indication of the third link satisfying a threshold associated with interference.

In some examples, the configuration for modifying the communication path is further based on a second condition associated with a third link between the first UE and a third UE, the second condition includes a second performance indication of the third link satisfying a threshold associated with interference.

Additionally, or alternatively, the communications manager 720 may support wireless communication at a first UE in accordance with examples as disclosed herein. In some examples, the communication component 735 may be configured as or otherwise support a means for communicating with a network entity over a communication path including a first link between the first UE and the network entity. In some examples, the configuration component 740 may be configured as or otherwise support a means for receiving a control message including a configuration for modifying the communication path based on a condition associated with the first link, where the configuration indicates one or more candidate UEs for relaying the communications between the first UE and the network entity upon satisfaction of the condition. In some examples, the channel access component 725 may be configured as or otherwise support a means for detecting the condition based on a performance indication of the first link. In some examples, the relay component 730 may be configured as or otherwise support a means for modifying the communication path based on detecting the condition.

In some examples, to support modifying the communication path, the relay component 730 may be configured as or otherwise support a means for modifying the communication path to include a second link between the first UE and a second UE configured to relay communications between the first UE and the network entity.

In some examples, the channel access component 725 may be configured as or otherwise support a means for receiving, from the network entity, a message including one or more parameters that indicate the performance indication of the first link, where the condition includes the performance indication satisfying a threshold associated with interference.

In some examples, the configuration for modifying the communication path is further based on a second condition associated with a second link between the first UE and one or more other UEs, the second condition including a second performance indication of the second link satisfying a threshold associated with interference.

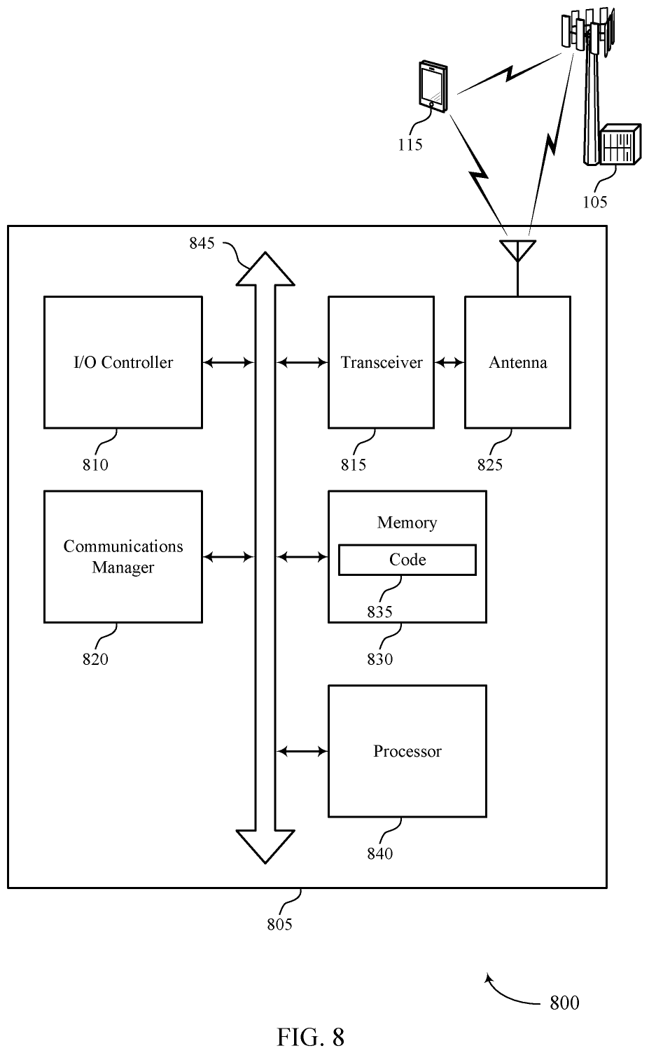

FIG. 8 shows a diagram of a system 800 including a device 805 that supports sidelink unlicensed channel relay selection in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting sidelink unlicensed channel relay selection). For example, the device 805 or a component of the device 805 may include a processor 840 and memory 830 coupled with or to the processor 840, the processor 840 and memory 830 configured to perform various functions described herein.

The communications manager 820 may support wireless communication at a first UE in accordance with examples as disclosed herein. For example, the communications manager 820 may be configured as or otherwise support a means for receiving, from one or more other UEs based on determining that a sidelink measurement associated with the one or more other UEs satisfies a first threshold, a message including one or more parameters associated with channel access by the one or more other UEs, where the one or more other UEs are candidate UEs for relaying communications between the first UE and a network entity. The communications manager 820 may be configured as or otherwise support a means for selecting a second UE of the one or more other UEs for relaying communications between the first UE and the network entity based on the one or more parameters satisfying a second threshold. The communications manager 820 may be configured as or otherwise support a means for communicating with the network entity via the second UE based on selecting the second UE for relaying the communications.

Additionally, or alternatively, the communications manager 820 may support wireless communication at a first UE in accordance with examples as disclosed herein. For example, the communications manager 820 may be configured as or otherwise support a means for communicating with a network entity over a communication path including a first link between the first UE and a second UE, the second UE configured to relay communications between the first UE and the network entity. The communications manager 820 may be configured as or otherwise support a means for receiving a control message including a configuration for modifying the communication path based on a condition associated with channel access, where the configuration indicates one or more candidate UEs for relaying the communications between the first UE and the network entity upon satisfaction of the condition. The communications manager 820 may be configured as or otherwise support a means for selecting a candidate UE of the one or more candidate UEs to establish a second link between the first UE and the candidate UE based on the configuration and determining that the condition associated with channel access is satisfied.

Additionally, or alternatively, the communications manager 820 may support wireless communication at a first UE in accordance with examples as disclosed herein. For example, the communications manager 820 may be configured as or otherwise support a means for communicating with a network entity over a communication path including a first link between the first UE and a second UE, the second UE configured to relay communications between the first UE and the network entity. The communications manager 820 may be configured as or otherwise support a means for receiving a control message including a configuration for modifying the communication path based on a condition associated with a second link between the second UE and the network entity. The communications manager 820 may be configured as or otherwise support a means for detecting the condition based on a performance indication of the second link. The communications manager 820 may be configured as or otherwise support a means for modifying the communication path based on detecting the condition.

Additionally, or alternatively, the communications manager 820 may support wireless communication at a first UE in accordance with examples as disclosed herein. For example, the communications manager 820 may be configured as or otherwise support a means for communicating with a network entity over a communication path including a first link between the first UE and the network entity. The communications manager 820 may be configured as or otherwise support a means for receiving a control message including a configuration for modifying the communication path based on a condition associated with the first link, where the configuration indicates one or more candidate UEs for relaying the communications between the first UE and the network entity upon satisfaction of the condition. The communications manager 820 may be configured as or otherwise support a means for detecting the condition based on a performance indication of the first link. The communications manager 820 may be configured as or otherwise support a means for modifying the communication path based on detecting the condition.

By including or configuring the communications manager 820 in accordance with examples as described herein, the device 805 may support techniques for reduced power consumption and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of sidelink unlicensed channel relay selection as described herein, or the processor 840 and the memory 830 may be otherwise configured to perform or support such operations.

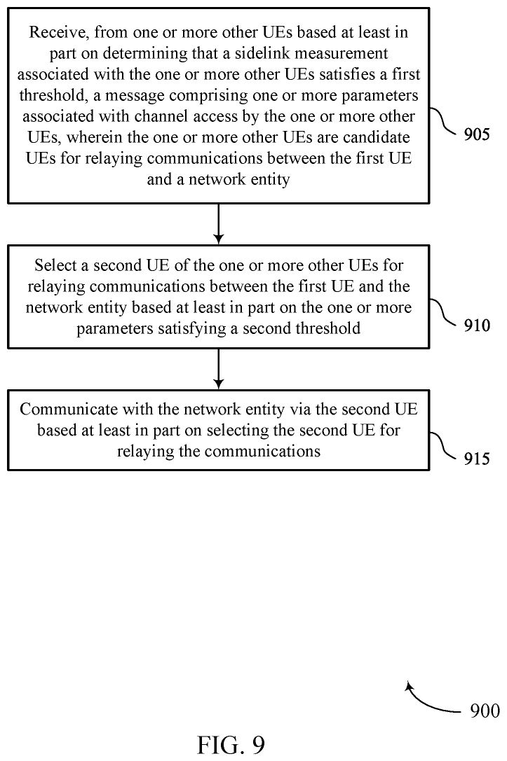

FIG. 9 shows a flowchart illustrating a method 900 that supports sidelink unlicensed channel relay selection in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving, from one or more other UEs based on determining that a sidelink measurement associated with the one or more other UEs satisfies a first threshold, a message including one or more parameters associated with channel access by the one or more other UEs, where the one or more other UEs are candidate UEs for relaying communications between the first UE and a network entity. The operations of 905 may be performed in accordance with examples as disclosed herein. In some examples, aspects of the operations of 905 may be performed by a channel access component 725 as described with reference to FIG. 7.

At 910, the method may include selecting a second UE of the one or more other UEs for relaying communications between the first UE and the network entity based on the one or more parameters satisfying a second threshold. The operations of 910 may be performed in accordance with examples as disclosed herein. In some examples, aspects of the operations of 910 may be performed by a relay component 730 as described with reference to FIG. 7.

At 915, the method may include communicating with the network entity via the second UE based on selecting the second UE for relaying the communications. The operations of 915 may be performed in accordance with examples as disclosed herein. In some examples, aspects of the operations of 915 may be performed by a communication component 735 as described with reference to FIG. 7.

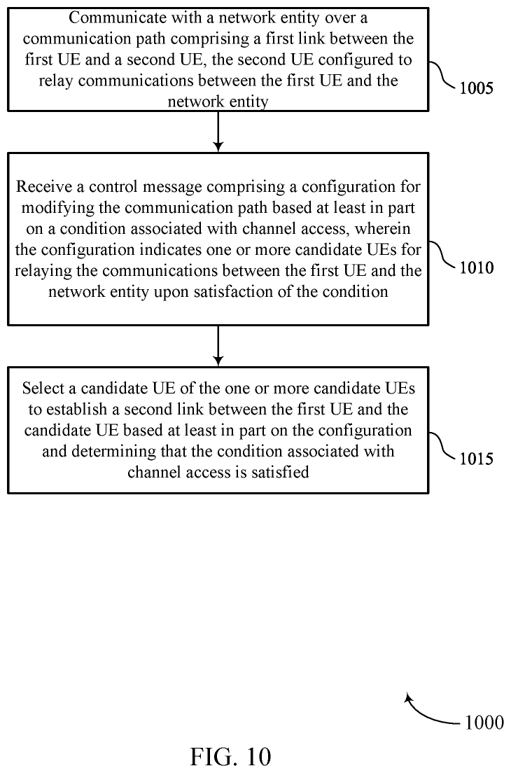

FIG. 10 shows a flowchart illustrating a method 1000 that supports sidelink unlicensed channel relay selection in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include communicating with a network entity over a communication path including a first link between the first UE and a second UE, the second UE configured to relay communications between the first UE and the network entity. The operations of 1005 may be performed in accordance with examples as disclosed herein. In some examples, aspects of the operations of 1005 may be performed by a communication component 735 as described with reference to FIG. 7.

At 1010, the method may include receiving a control message including a configuration for modifying the communication path based on a condition associated with channel access, where the configuration indicates one or more candidate UEs for relaying the communications between the first UE and the network entity upon satisfaction of the condition. The operations of 1010 may be performed in accordance with examples as disclosed herein. In some examples, aspects of the operations of 1010 may be performed by a configuration component 740 as described with reference to FIG. 7.

At 1015, the method may include selecting a candidate UE of the one or more candidate UEs to establish a second link between the first UE and the candidate UE based on the configuration and determining that the condition associated with channel access is satisfied. The operations of 1015 may be performed in accordance with examples as disclosed herein. In some examples, aspects of the operations of 1015 may be performed by a relay component 730 as described with reference to FIG. 7.

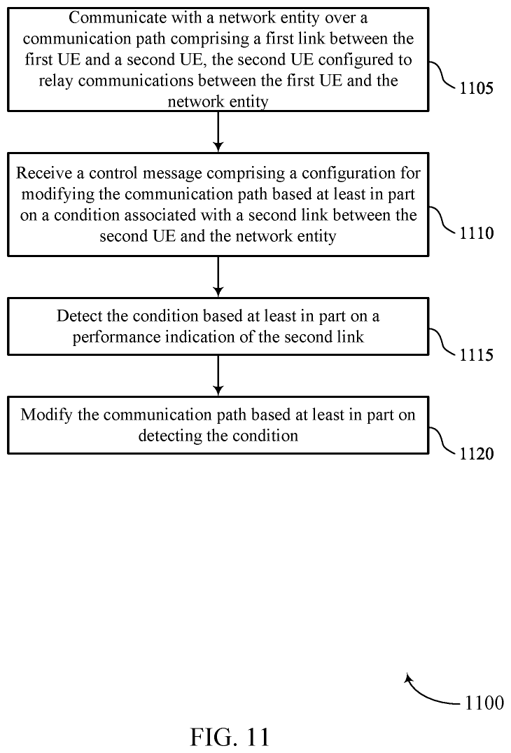

FIG. 11 shows a flowchart illustrating a method 1100 that supports sidelink unlicensed channel relay selection in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include communicating with a network entity over a communication path including a first link between the first UE and a second UE, the second UE configured to relay communications between the first UE and the network entity. The operations of 1105 may be performed in accordance with examples as disclosed herein. In some examples, aspects of the operations of 1105 may be performed by a communication component 735 as described with reference to FIG. 7.

At 1110, the method may include receiving a control message including a configuration for modifying the communication path based on a condition associated with a second link between the second UE and the network entity. The operations of 1110 may be performed in accordance with examples as disclosed herein. In some examples, aspects of the operations of 1110 may be performed by a configuration component 740 as described with reference to FIG. 7.

At 1115, the method may include detecting the condition based on a performance indication of the second link. The operations of 1115 may be performed in accordance with examples as disclosed herein. In some examples, aspects of the operations of 1115 may be performed by a channel access component 725 as described with reference to FIG. 7.

At 1120, the method may include modifying the communication path based on detecting the condition. The operations of 1120 may be performed in accordance with examples as disclosed herein. In some examples, aspects of the operations of 1120 may be performed by a relay component 730 as described with reference to FIG. 7.

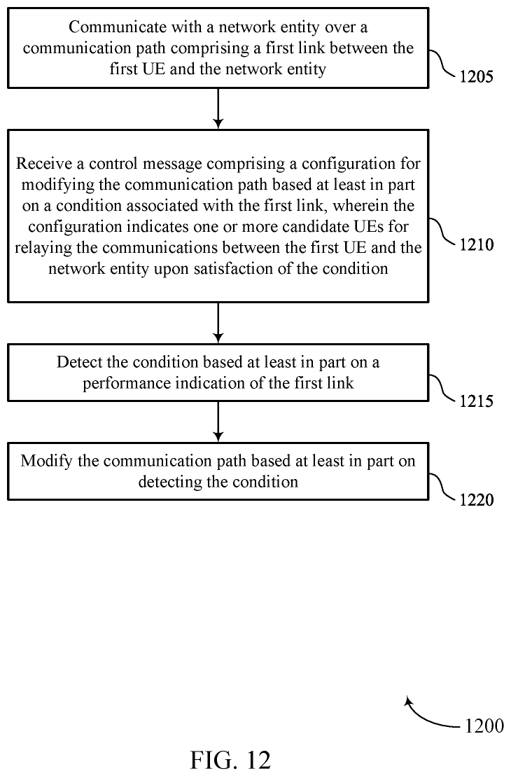

FIG. 12 shows a flowchart illustrating a method 1200 that supports sidelink unlicensed channel relay selection in accordance with one or more aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include communicating with a network entity over a communication path including a first link between the first UE and the network entity. The operations of 1205 may be performed in accordance with examples as disclosed herein. In some examples, aspects of the operations of 1205 may be performed by a communication component 735 as described with reference to FIG. 7.

At 1210, the method may include receiving a control message including a configuration for modifying the communication path based on a condition associated with the first link, where the configuration indicates one or more candidate UEs for relaying the communications between the first UE and the network entity upon satisfaction of the condition. The operations of 1210 may be performed in accordance with examples as disclosed herein. In some examples, aspects of the operations of 1210 may be performed by a configuration component 740 as described with reference to FIG. 7.

At 1215, the method may include detecting the condition based on a performance indication of the first link. The operations of 1215 may be performed in accordance with examples as disclosed herein. In some examples, aspects of the operations of 1215 may be performed by a channel access component 725 as described with reference to FIG. 7.

At 1220, the method may include modifying the communication path based on detecting the condition. The operations of 1220 may be performed in accordance with examples as disclosed herein. In some examples, aspects of the operations of 1220 may be performed by a relay component 730 as described with reference to FIG. 7.

The following provides an overview of aspects of the present disclosure:

Aspect 1: A method for wireless communication at a first UE, comprising: receiving, from one or more other UEs based at least in part on determining that a sidelink measurement associated with the one or more other UEs satisfies a first threshold, a message comprising one or more parameters associated with channel access by the one or more other UEs, wherein the one or more other UEs are candidate UEs for relaying communications between the first UE and a network entity; selecting a second UE of the one or more other UEs for relaying communications between the first UE and the network entity based at least in part on the one or more parameters satisfying a second threshold; and communicating with the network entity via the second UE based at least in part on selecting the second UE for relaying the communications.

Aspect 2: The method of aspect 1, further comprising: determining a quantity of failures associated with a link between the first UE and a third UE within a time duration; and determining that the quantity of failures satisfies a third threshold, wherein selecting the second UE for relaying communications is further based at least in part on the quantity of failures satisfying the third threshold.

Aspect 3: The method of aspect 2, further comprising: storing an indication of the link between the first UE and the third UE based at least in part on determining that the quantity of failures satisfies the third threshold, wherein selecting the second UE rather than the third UE for relaying communications between the first UE and the network entity is based at least in part on storing the indication of the link between the first UE and the third UE.

Aspect 4: The method of any of aspects 1 through 3, further comprising: receiving, from a third UE configured to relay communications between the first UE and the network entity, a second message indicating one or more failures associated with a first link between the third UE and the network entity within a time duration; and determining whether to release a second link between the first UE and the third UE based at least in part on the one or more failures.

Aspect 5: The method of any of aspects 1 through 4, further comprising: transmitting, to a third UE configured for relaying communications between the first UE and the network entity, a control message comprising the one or more parameters; and receiving an indication to perform a communication path modification based at least in part on transmitting the control message, wherein selecting the second UE is further based at least in part on the indication.

Aspect 6: The method of aspect 5, further comprising: receiving a second message comprising a second indication to transmit the control message, wherein transmitting the control message is based at least in part on receiving the second message.

Aspect 7: The method of any of aspects 1 through 6, wherein the one or more parameters comprise a combination of a likelihood of failure associated with a first link between the first UE and the one or more other UEs and a likelihood of failure associated with a second link between the one or more other UEs and the network entity.

Aspect 8: The method of any of aspects 1 through 7, wherein the message is a discovery message associated with a relay selection procedure.

Aspect 9: The method of any of aspects 1 through 8, wherein the one or more parameters for reselection comprises a LBT counter, a CBR value, a likelihood of failure of a LBT procedure associated with a link between the first UE and the second UE, or any combination thereof.

Aspect 10: The method of aspect 9, wherein the LBT counter comprises an average of LBT failures associated with one or more links between a respective UE of the one or more other UEs and a respective third UE.

Aspect 11: The method of any of aspects 9 through 10, further comprising: measuring interference at the first UE, wherein the CBR value is associated with the interference.

Aspect 12: A method for wireless communication at a first UE, comprising: communicating with a network entity over a communication path comprising a first link between the first UE and a second UE, the second UE configured to relay communications between the first UE and the network entity; receiving a control message comprising a configuration for modifying the communication path based at least in part on a condition associated with channel access, wherein the configuration indicates one or more candidate UEs for relaying the communications between the first UE and the network entity upon satisfaction of the condition; and selecting a candidate UE of the one or more candidate UEs to establish a second link between the first UE and the candidate UE based at least in part on the configuration and determining that the condition associated with channel access is satisfied.

Aspect 13: The method of aspect 12, further comprising: receiving, from the second UE, a second control message based at least in part on a quantity of failures associated with channel access of the first link, wherein selecting the candidate UE is further based at least in part on the control message.

Aspect 14: The method of any of aspects 12 through 13, further comprising: initiating a random access procedure associated with establishing or reestablishing a third link between the first UE and the network entity based at least in part on the configuration for modifying the communication path.

Aspect 15: The method of any of aspects 12 through 14, further comprising: determining a quantity of failures associated with channel access of the first link within a time window; and indicating to upper layers of a communication stack the quantity of failures based at least in part on determining that the quantity of failures satisfies a threshold, wherein the condition comprises the quantity of failures satisfying the threshold.

Aspect 16: The method of any of aspects 12 through 15, further comprising: determining whether a failure associated with channel access has occurred on each subchannel of a set of subchannels associated with the first link, wherein selecting the candidate UE of the one or more candidate UEs is further based at least in part on determining that a respective failure associated with channel access has occurred on each subchannel of the set of subchannels.

Aspect 17: The method of any of aspects 12 through 16, further comprising: determining whether a failure associated with channel access has occurred with each candidate UE of the one or more candidate UEs based at least in part on determining a second failure associated with a third link between the first UE and the network entity, wherein selecting the candidate UE of the one or more candidate UEs is further based at least in part on determining that the failure has not occurred with the candidate UE.

Aspect 18: The method of any of aspects 12 through 17, further comprising: transmitting, to a third UE, a second control message indicating to perform a relay selection procedure, wherein the first UE is configured to relay communications between the third UE and the network entity.

Aspect 19: The method of any of aspects 12 through 18, further comprising: determining a channel access failure associated with the first link or a third link between the first UE and the network entity; and activating packet data convergence protocol duplication for the first link, the second link, the third link, or any combination thereof, based at least in part on the configuration.

Aspect 20: A method for wireless communication at a first UE, comprising: communicating with a network entity over a communication path comprising a first link between the first UE and a second UE, the second UE configured to relay communications between the first UE and the network entity; receiving a control message comprising a configuration for modifying the communication path based at least in part on a condition associated with a second link between the second UE and the network entity; detecting the condition based at least in part on a performance indication of the second link; and modifying the communication path based at least in part on detecting the condition.

Aspect 21: The method of aspect 20, wherein modifying the communication path comprises: modifying the communication path to include a third link between the first UE and the network entity or a fourth link between the first UE and a third UE and a fifth link between the third UE and the network entity.

Aspect 22: The method of any of aspects 20 through 21, further comprising: receiving, from the second UE, a message comprising one or more parameters that indicate the performance indication of the second link, wherein the condition comprises the performance indication satisfying a threshold associated with interference.

Aspect 23: The method of any of aspects 20 through 22, wherein the configuration for modifying the communication path is further based at least in part on a second condition associated with a third link between the first UE and the network entity.

Aspect 24: The method of aspect 23, wherein the second condition comprises a second performance indication of the third link satisfying a threshold associated with interference.

Aspect 25: The method of any of aspects 20 through 24, wherein the configuration for modifying the communication path is further based at least in part on a second condition associated with a third link between the first UE and a third UE, the second condition comprises a second performance indication of the third link satisfying a threshold associated with interference.

Aspect 26: A method for wireless communication at a first UE, comprising: communicating with a network entity over a communication path comprising a first link between the first UE and the network entity; receiving a control message comprising a configuration for modifying the communication path based at least in part on a condition associated with the first link, wherein the configuration indicates one or more candidate UEs for relaying the communications between the first UE and the network entity upon satisfaction of the condition; detecting the condition based at least in part on a performance indication of the first link; and modifying the communication path based at least in part on detecting the condition.

Aspect 27: The method of aspect 26, wherein modifying the communication path comprises: modifying the communication path to include a second link between the first UE and a second UE configured to relay communications between the first UE and the network entity.

Aspect 28: The method of any of aspects 26 through 27, further comprising: receiving, from the network entity, a message comprising one or more parameters that indicate the performance indication of the first link, wherein the condition comprises the performance indication satisfying a threshold associated with interference.

Aspect 29: The method of any of aspects 26 through 28, wherein the configuration for modifying the communication path is further based at least in part on a second condition associated with a second link between the first UE and one or more other UEs, the second condition comprising a second performance indication of the second link satisfying a threshold associated with interference.

Aspect 30: An apparatus for wireless communication at a first UE, comprising a processor; memory coupled with the processor; and instructions stored in the memory and executable by the processor to cause the apparatus to perform a method of any of aspects 1 through 11.

Aspect 31: An apparatus for wireless communication at a first UE, comprising at least one means for performing a method of any of aspects 1 through 11.

Aspect 32: A non-transitory computer-readable medium storing code for wireless communication at a first UE, the code comprising instructions executable by a processor to perform a method of any of aspects 1 through 11.

Aspect 33: An apparatus for wireless communication at a first UE, comprising a processor; memory coupled with the processor; and instructions stored in the memory and executable by the processor to cause the apparatus to perform a method of any of aspects 12 through 19.

Aspect 34: An apparatus for wireless communication at a first UE, comprising at least one means for performing a method of any of aspects 12 through 19.

Aspect 35: A non-transitory computer-readable medium storing code for wireless communication at a first UE, the code comprising instructions executable by a processor to perform a method of any of aspects 12 through 19.

Aspect 36: An apparatus for wireless communication at a first UE, comprising a processor; memory coupled with the processor; and instructions stored in the memory and executable by the processor to cause the apparatus to perform a method of any of aspects 20 through 25.

Aspect 37: An apparatus for wireless communication at a first UE, comprising at least one means for performing a method of any of aspects 20 through 25.

Aspect 38: A non-transitory computer-readable medium storing code for wireless communication at a first UE, the code comprising instructions executable by a processor to perform a method of any of aspects 20 through 25.

Aspect 39: An apparatus for wireless communication at a first UE, comprising a processor; memory coupled with the processor; and instructions stored in the memory and executable by the processor to cause the apparatus to perform a method of any of aspects 26 through 29.

Aspect 40: An apparatus for wireless communication at a first UE, comprising at least one means for performing a method of any of aspects 26 through 29.

Aspect 41: A non-transitory computer-readable medium storing code for wireless communication at a first UE, the code comprising instructions executable by a processor to perform a method of any of aspects 26 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processor;
memory coupled with the processor; and
instructions stored in the memory and executable by the processor to cause the apparatus to:
receive, from one or more other UEs based at least in part on determining that a sidelink measurement associated with the one or more other UEs satisfies a first threshold, a message comprising one or more parameters associated with channel access by the one or more other UEs, wherein the one or more other UEs are candidate UEs for relaying communications between the first UE and a network entity;
select a second UE of the one or more other UEs for relaying communications between the first UE and the network entity based at least in part on the one or more parameters satisfying a second threshold; and
communicate with the network entity via the second UE based at least in part on selecting the second UE for relaying the communications.

2. The apparatus of claim 1, wherein the instructions are further executable by the processor to cause the apparatus to:
determine a quantity of failures associated with a link between the first UE and a third UE within a time duration; and
determine that the quantity of failures satisfies a third threshold, wherein selecting the second UE for relaying communications is further based at least in part on the quantity of failures satisfying the third threshold.

3. The apparatus of claim 2, wherein the instructions are further executable by the processor to cause the apparatus to:
store an indication of the link between the first UE and the third UE based at least in part on determining that the quantity of failures satisfies the third threshold, wherein selecting the second UE rather than the third UE for relaying communications between the first UE and the network entity is based at least in part on storing the indication of the link between the first UE and the third UE.

4. The apparatus of claim 1, wherein the instructions are further executable by the processor to cause the apparatus to:
receive, from a third UE configured to relay communications between the first UE and the network entity, a second message indicating one or more failures associated with a first link between the third UE and the network entity within a time duration; and
determine whether to release a second link between the first UE and the third UE based at least in part on the one or more failures.

5. The apparatus of claim 1, wherein the instructions are further executable by the processor to cause the apparatus to:
transmit, to a third UE configured for relaying communications between the first UE and the network entity, a control message comprising the one or more parameters; and
receive an indication to perform a communication path modification based at least in part on transmitting the control message, wherein selecting the second UE is further based at least in part on the indication.

6. The apparatus of claim 5, wherein the instructions are further executable by the processor to cause the apparatus to:
receive a second message comprising a second indication to transmit the control message, wherein transmitting the control message is based at least in part on receiving the second message.

7. The apparatus of claim 1, wherein the one or more parameters comprise a combination of a likelihood of failure associated with a first link between the first UE and the one or more other UEs and a likelihood of failure associated with a second link between the one or more other UEs and the network entity.

8. The apparatus of claim 1, wherein the message is a discovery message associated with a relay selection procedure.

9. The apparatus of claim 1, wherein the one or more parameters for reselection comprises a listen-before-talk counter, a channel busy ratio value, a likelihood of failure of a listen-before-talk procedure associated with a link between the first UE and the second UE, or any combination thereof.

10. The apparatus of claim 9, wherein the listen-before-talk counter comprises an average of listen-before-talk failures associated with one or more links between a respective UE of the one or more other UEs and a respective third UE.

11. The apparatus of claim 9, wherein the instructions are further executable by the processor to cause the apparatus to:
measure interference at the first UE, wherein the channel busy ratio value is based at least in part on the measured interference.

12. An apparatus for wireless communication at a first user equipment (UE), comprising:
a processor;
memory coupled with the processor; and
instructions stored in the memory and executable by the processor to cause the apparatus to:
communicate with a network entity over a communication path comprising a first link between the first UE and a second UE, the second UE configured to relay communications between the first UE and the network entity;
receive a control message comprising a configuration for modifying the communication path based at least in part on a condition associated with channel access, wherein the configuration indicates one or more candidate UEs for relaying the communications between the first UE and the network entity upon satisfaction of the condition; and
select a candidate UE of the one or more candidate UEs to establish a second link between the first UE and the candidate UE based at least in part on the configuration and determining that the condition associated with channel access is satisfied.

13. The apparatus of claim 12, wherein the instructions are further executable by the processor to cause the apparatus to:
receive, from the second UE, a second control message based at least in part on a quantity of failures associated with channel access of the first link, wherein selecting the candidate UE is further based at least in part on the control message.

14. The apparatus of claim 12, wherein the instructions are further executable by the processor to cause the apparatus to:
initiate a random access procedure associated with establishing or reestablishing a third link between the first UE and the network entity based at least in part on the configuration for modifying the communication path.

15. The apparatus of claim 12, wherein the instructions are further executable by the processor to cause the apparatus to:
determine a quantity of failures associated with channel access of the first link within a time window; and
indicate to upper layers of a communication stack the quantity of failures based at least in part on determining that the quantity of failures satisfies a threshold, wherein the condition comprises the quantity of failures satisfying the threshold.

16. The apparatus of claim 12, wherein the instructions are further executable by the processor to cause the apparatus to:
determine whether a failure associated with channel access has occurred on each subchannel of a set of subchannels associated with the first link, wherein selecting the candidate UE of the one or more candidate UEs is further based at least in part on determining that a respective failure associated with channel access has occurred on each subchannel of the set of subchannels.

17. The apparatus of claim 12, wherein the instructions are further executable by the processor to cause the apparatus to:
determine whether a failure associated with channel access has occurred with each candidate UE of the one or more candidate UEs based at least in part on determining a second failure associated with a third link between the first UE and the network entity, wherein selecting the candidate UE of the one or more candidate UEs is further based at least in part on determining that the failure has not occurred with the candidate UE.

18. The apparatus of claim 12, wherein the instructions are further executable by the processor to cause the apparatus to:
transmit, to a third UE, a second control message indicating to perform a relay selection procedure, wherein the first UE is configured to relay communications between the third UE and the network entity.

19. The apparatus of claim 12, wherein the instructions are further executable by the processor to cause the apparatus to:
determine a channel access failure associated with the first link or a third link between the first UE and the network entity; and
activate packet data convergence protocol duplication for the first link, the second link, the third link, or any combination thereof, based at least in part on the configuration.

20. An apparatus for wireless communication at a first user equipment (UE), comprising:
a processor;
memory coupled with the processor; and
instructions stored in the memory and executable by the processor to cause the apparatus to:
communicate with a network entity over a communication path comprising a first link between the first UE and a second UE, the second UE configured to relay communications between the first UE and the network entity;
receive a control message comprising a configuration for modifying the communication path based at least in part on a condition associated with a second link between the second UE and the network entity;
detect the condition based at least in part on a performance indication of the second link; and
modify the communication path based at least in part on detecting the condition.

21. The apparatus of claim 20, wherein the instructions to modify the communication path are executable by the processor to cause the apparatus to:
modify the communication path to include a third link between the first UE and the network entity or a fourth link between the first UE and a third UE and a fifth link between the third UE and the network entity.

22. The apparatus of claim 20, wherein the instructions are further executable by the processor to cause the apparatus to:
receive, from the second UE, a message comprising one or more parameters that indicate the performance indication of the second link, wherein the condition comprises the performance indication satisfying a threshold associated with interference.

23. The apparatus of claim 20, wherein the configuration for modifying the communication path is further based at least in part on a second condition associated with a third link between the first UE and the network entity.

24. The apparatus of claim 23, wherein the second condition comprises a second performance indication of the third link satisfying a threshold associated with interference.

25. The apparatus of claim 20, wherein the configuration for modifying the communication path is further based at least in part on a second condition associated with a third link between the first UE and a third UE, the second condition comprises a second performance indication of the third link satisfying a threshold associated with interference.

26. An apparatus for wireless communication at a first user equipment (UE), comprising:
a processor;
memory coupled with the processor; and
instructions stored in the memory and executable by the processor to cause the apparatus to:
communicate with a network entity over a communication path comprising a first link between the first UE and the network entity;
receive a control message comprising a configuration for modifying the communication path based at least in part on a condition associated with the first link, wherein the configuration indicates one or more candidate UEs for relaying the communications between the first UE and the network entity upon satisfaction of the condition;
detect the condition based at least in part on a performance indication of the first link; and
modify the communication path based at least in part on detecting the condition.

27. The apparatus of claim 26, wherein the instructions to modify the communication path are executable by the processor to cause the apparatus to:
modify the communication path to include a second link between the first UE and a second UE configured to relay communications between the first UE and the network entity.

28. The apparatus of claim 26, wherein the instructions are further executable by the processor to cause the apparatus to:
receive, from the network entity, a message comprising one or more parameters that indicate the performance indication of the first link, wherein the condition comprises the performance indication satisfying a threshold associated with interference.

29. The apparatus of claim 26, wherein the configuration for modifying the communication path is further based at least in part on a second condition associated with a second link between the first UE and one or more other UEs, the second condition comprising a second performance indication of the second link satisfying a threshold associated with interference.
